(19) United States
(12) Patent Application Publication
(10) Pub. No.: US 2026/0095557 A1
(43) Pub. Date: Apr. 2, 2026

(54) CORRECTION METHOD, PROJECTING APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Shiki FURUI, Matsumoto-shi (JP); Momoko IMAI, Matsumoto-shi (JP)

(73) Assignee: SEIKO EPSON CORPORATION, Tokyo (JP)

(21) Appl. No.: 19/342,263

(22) Filed: Sep. 26, 2025

(30) Foreign Application Priority Data
Sep. 27, 2024 (JP) 2024-168756

(51) Int. Cl. H04N 9/31

(52) U.S. Cl. CPC H04N 9/3182; H04N 9/3194

(57) ABSTRACT

A projection image PI has a first area RL1 overlapping a first projection image PI1, a second area RL4 overlapping a second projection image PI3, and a third area RL3 not overlapping the first projection image PI1 and the second projection image PI3 in a state in which the projection image PI is projected onto a projection surface SC, and a correction value of a parameter that defines brightness of the third area RL3 is calculated based on a first target value that is a target of brightness of a first color component in the first area RL1 and a second target value that is a target of brightness of the first color component in the second area RL4 so that a distribution of the parameter is a continuous or stepwise distribution in a first direction from the first area RL1 toward the second area RL4.

The present application is based on, and claims priority from JP Application Serial Number 2024-168756, filed Sep. 27, 2024, the disclosure of which is hereby incorporated by reference herein in its entirety.

### BACKGROUND

### 1. Technical Field

The present disclosure relates to a correction method, a projecting apparatus, and a non-transitory computer-readable storage medium storing a program.

### 2. Related Art

JP-A-2018-5018 discloses a projecting system that projects a tiled image by combining projection images of a plurality of projecting apparatuses. Specifically, in the technique disclosed in JP-A-2018-5018, a first projecting apparatus projects a first projection image, a second projecting apparatus projects a second projection image, and a third projecting apparatus projects a third projection image. A part of the first projection image and a part of the second projection image overlap each other to generate a first overlapping area. A part of the second projection image and a part of the third projection image overlap each other to generate a second overlapping area.

JP-A-2018-5018 is an example of the related art.

There is an individual difference in contrast ratio between projecting apparatuses. In the technique disclosed in JP-A-2018-5018, when brightness of the first overlapping area and brightness of the second overlapping area are to be the same, it is necessary to adjust, to the brightness of the darker overlapping area, the brightness of the other overlapping area, due to individual differences in contrast ratio. However, when the brightness of the other overlapping area is adjusted to that of the darker overlapping area, the contrast ratio of the entire projection image may deteriorate.

### SUMMARY

A correction method according to an aspect of the present disclosure is a correction method for a projection image projected from a projecting apparatus, the correction method including: acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data; and calculating correction data for correcting a color of an image displayed on the projection surface based on the plurality of pieces of gradation data and the plurality of pieces of measurement data, in which the projection image has a first area overlapping the first projection image, a second area overlapping the second projection image, and a third area not overlapping the first projection image and the second projection image in a state in which the projection image is projected onto the projection surface, the plurality of pieces of gradation data include at least one gradation value indicating at least one gradation of a first color component, the plurality of pieces of measurement data include a brightness value indicating brightness of reflected light of colored light corresponding to the first color component having the at least one gradation value, and the calculating the correction data includes determining a first target value that is a target of brightness of the first color component in the first area and a second target value that is a target of brightness of the first color component in the second area based on the plurality of pieces of gradation data and the plurality of pieces of measurement data, and calculating a correction value of a parameter that defines brightness of the third area, based on the first target value and the second target value, such that a distribution of the parameter is a continuous or stepwise distribution in a first direction from the first area toward the second area.

A projecting apparatus according to an aspect of the present disclosure is a projecting apparatus that executes: acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data; and calculating correction data for correcting a color of an image displayed on the projection surface based on the plurality of pieces of gradation data and the plurality of pieces of measurement data, in which the projection image has a first area overlapping the first projection image, a second area overlapping the second projection image, and a third area not overlapping the first projection image and the second projection image in a state in which the projection image is projected onto the projection surface, the plurality of pieces of gradation data include at least one gradation value indicating at least one gradation of a first color component, the plurality of pieces of measurement data include a brightness value indicating brightness of reflected light of colored light corresponding to the first color component having the at least one gradation value, and the calculating the correction data includes determining a first target value that is a target of brightness of the first color component in the first area and a second target value that is a target of brightness of the first color component in the second area based on the plurality of pieces of gradation data and the plurality of pieces of measurement data, and calculating a correction value of a parameter that defines brightness of the third area, based on the first target value and the second target value, so that a distribution of the parameter is a continuous or stepwise distribution in a first direction from the first area toward the second area.

A non-transitory computer-readable storage medium storing a program according to an aspect of the present disclosure is a non-transitory computer-readable storage medium storing a program, the program including causing a projecting apparatus to execute acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data, and calculating correction data for correcting a color of an image displayed on the projection surface based on the plurality of pieces of gradation data and the plurality of pieces of measurement data, in which the projection image has a first area overlapping the first projection image, a second area overlapping the second projection image, and a third area not overlapping the first projection image and the second projection image in a state in which the projection image is projected onto the projection surface, the plurality of pieces of gradation data include at least one gradation value indicating at least one gradation of a first color component, the plurality of pieces of measurement data include a brightness value indicating brightness of reflected light of colored light corresponding to the first color component having the at least one gradation value, and the calculating the correction data includes determining a first target value that is a target of brightness of the first color component in the first area and a second target value that is a target of brightness of the first color component in the second area based on the plurality of pieces of gradation data and the plurality of pieces of measurement data, and calculating a correction value of a parameter that defines brightness of the third area, based on the first target value and the second target value, so that a distribution of the parameter is a continuous or stepwise distribution in a first direction from the first area toward the second area.

### BRIEF DESCRIPTION OF THE DRAWINGS

FIG. 1 is a diagram illustrating an overall configuration of a projecting system 1.

FIG. 2 is a block diagram of a projecting apparatus 10A.

FIG. 3 is a graph illustrating a γ curve corresponding to a relationship between an input gradation and an output luminance in an overlapping area DR.

FIG. 4 is a graph illustrating a γ curve corresponding to a relationship between the input gradation and the output luminance in a non-overlapping area NR.

FIG. 5 is a graph illustrating a γ curve corresponding to a relationship between the input gradation and the output luminance in the overlapping area DR and the non-overlapping area NR.

FIG. 6 is a diagram illustrating a projecting method for a measurement pattern by the projecting apparatus 10A.

FIG. 7 is a functional block diagram of a corrector 136.

FIG. 8 is a flowchart illustrating an operation example of the projecting apparatus 10A according to a first embodiment.

FIG. 9 is a diagram illustrating an example of lattice points LP.

FIG. 10 is a diagram illustrating an example of the lattice points LP.

FIG. 11 is a diagram illustrating an example of the lattice points LP.

FIG. 12 is a diagram illustrating an example of an interpolation curve R(r, 34, 34) for interpolating a measured value of a R component among measured values (R, G, B) calculated by a processing device 13.

FIG. 13 is a diagram illustrating an example of an interpolation curve G(r, 34, 34) for interpolating a measured value of a G component among the measured values (R, G, B) calculated by the processing device 13.

FIG. 14 is a diagram illustrating an example of an interpolation curve B(r, 34, 34) for interpolating a measured value of a B component among the measured values (R, G, B) calculated by the processing device 13.

FIG. 15 is a diagram illustrating an example of an interpolation curve R(34, g, 34) for interpolating a measured value of the R component among measured values (R, G, B) calculated by the processing device 13.

FIG. 16 is a diagram illustrating an example of an interpolation curve G(34, g, 34) for interpolating a measured value of the G component among the measured values (R, G, B) calculated by the processing device 13.

FIG. 17 is a diagram illustrating an example of an interpolation curve B(34, g, 34) for interpolating a measured value of the B component among the measured values (R, G, B) calculated by the processing device 13.

FIG. 18 is a diagram illustrating an example of an interpolation curve R(34, 34, b) for interpolating a measured value of the R component among the measured values (R, G, B) calculated by the processing device 13.

FIG. 19 is a diagram illustrating an example of an interpolation curve G(34, 34, b) for interpolating a measured value of the G component among the measured values (R, G, B) calculated by the processing device 13.

FIG. 20 is a diagram illustrating an example of an interpolation curve B(34, 34, b) for interpolating a measured value of the B component among the measured values (R, G, B) calculated by the processing device 13.

FIG. 21 is a flowchart illustrating sub-steps SS4[1] to SS4[7] constituting step S4.

FIG. 22 is a diagram illustrating an example of gradation values (r, g, b) as correction values at a lattice point DP.

FIG. 23 is a diagram illustrating an example of gradation values (r, g, b) as correction values at a lattice point DP and gradation values t at lattice points NP adjacent to a boundary between the overlapping area DR and the non-overlapping area NR.

FIG. 24 is a diagram illustrating an example of a method for determining the gradation value t as a target value of the lattice point NP for which the gradation value t as the target value is not determined.

FIG. 25 is a diagram illustrating an example of the method for determining the gradation value t as the target value of the lattice point NP for which the gradation value t as the target value is not determined.

FIG. 26 is a diagram illustrating an example of a calculation situation of the gradation value t as the target value.

FIG. 27 is a diagram illustrating an example of a calculation situation of the gradation value t as the target value.

FIG. 28 is a diagram illustrating an example of a calculation situation of the gradation value t as the target value.

FIG. 29 is a diagram illustrating an example of smoothing.

FIG. 30 is a diagram illustrating an example of smoothing.

FIG. 31 is a diagram illustrating an example of a situation of smoothing of the gradation value t as the target value.

FIG. 32 is a diagram illustrating an example of the situation of smoothing of the gradation value t as the target value.

FIG. 33 is a diagram illustrating an example of the situation of smoothing of the gradation value t as the target value.

FIG. 34 is a diagram illustrating a stereoscopic display of the target value of each lattice point NP before smoothing.

FIG. 35 is a diagram illustrating a stereoscopic display of the target value of each lattice point NP after the smoothing is completed.

FIG. 36 is a diagram illustrating a method for determining target values of brightness and a chromaticity at each of the lattice point DP and the lattice point NP according to Modification 1.

FIG. 37 is a diagram illustrating the method for determining the target values of the brightness and the chromaticity at each of the lattice point DP and the lattice point NP according to Modification 1.

FIG. 38 is a diagram illustrating the method for determining the target values of the brightness and the chromaticity at each of the lattice point DP and the lattice point NP according to Modification 1.

### DESCRIPTION OF EMBODIMENTS

An aspect for implementing the present disclosure will hereinafter be described with reference to the drawings. Note, however, that dimensions and scales of portions in the drawings are made different from actual ones as appropriate. Furthermore, the embodiment described below is a preferable specific example of the present disclosure, and various technically preferable restrictions are therefore imposed on the embodiment, but the scope of the present disclosure is not limited to the embodiment unless there is a description that the present disclosure is particularly limited to the embodiment in the following description.

### 1: First Embodiment

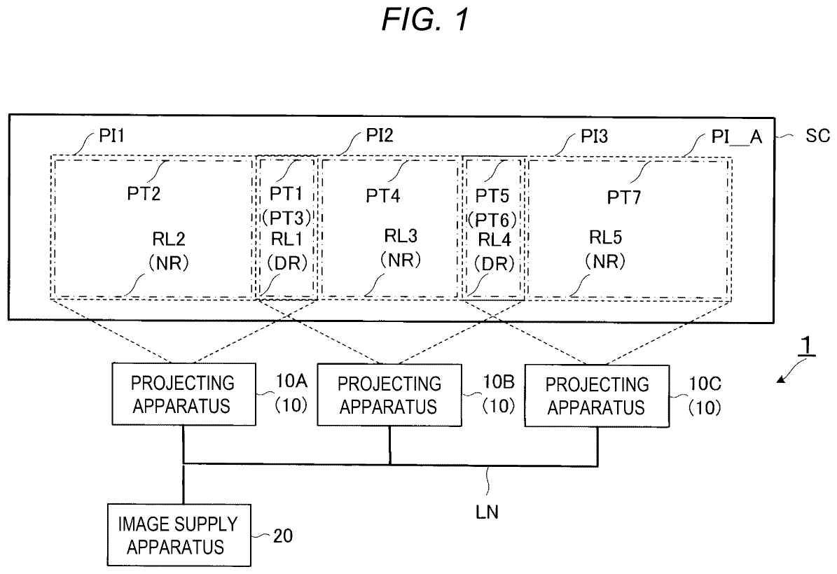

Hereinafter, a projecting system 1 according to a first embodiment will be described with reference to FIGS. 1 to 35.

### 1-1: Configuration of First Embodiment

### 1-1-1: Overall Configuration

FIG. 1 is a diagram illustrating an overall configuration of the projecting system 1. The projecting system 1 includes a projecting apparatus 10A, a projecting apparatus 10B, a projecting apparatus 10C, and an image supply apparatus 20. The projecting apparatus 10A is an example of a “first projecting apparatus”. The projecting apparatus 10B is an example of a “projecting apparatus”. The projecting apparatus 10C is an example of a “second projecting apparatus”.

The projecting apparatus 10A, the projecting apparatus 10B, the projecting apparatus 10C, and the image supply apparatus 20 are communicably coupled to each other via a communication line LN.

The projecting apparatus 10A, the projecting apparatus 10B, and the projecting apparatus 10C project various images or videos onto a projection surface SC. As an example, among the projecting apparatus 10A, the projecting apparatus 10B, and the projecting apparatus 10C, the projecting apparatus 10B is a primary projecting apparatus for the projecting apparatus 10A and the projecting apparatus 10C. The projecting apparatus 10A and the projecting apparatus 10C are secondary projecting apparatuses for the projecting apparatus 10B. Specifically, the projecting apparatus 10B transmits various control signals to each of the projecting apparatus 10A and the projecting apparatus 10C. As a result, the projecting apparatus 10B controls the projecting apparatus 10A and the projecting apparatus 10C. The control signal described above includes various correction values to be described later.

The image supply apparatus 20 supplies various images to the projecting apparatus 10A, the projecting apparatus 10B, and the projecting apparatus 10C. Each of the projecting apparatus 10A, the projecting apparatus 10B, and the projecting apparatus 10C projects the image supplied from the image supply apparatus 20 onto the projection surface SC.

Alternatively, the image supply apparatus 20 may supply the image only to the projecting apparatus 10B, and the projecting apparatus 10B may supply the image to be projected by each projecting apparatus 10 to each of the projecting apparatus 10A and the projecting apparatus 10C. In the present embodiment, when the projecting apparatus 10A to the projecting apparatus 10C are not distinguished, they are referred to as the projecting apparatus 10.

In the projecting system 1, each of the projecting apparatus 10A, the projecting apparatus 10B, and the projecting apparatus 10C may read an image to be projected from a storage device 14 provided therein and project the image onto the projection surface SC. Alternatively, the projecting apparatus 10B may read the image to be projected from the storage device 14 provided in the projecting apparatus 10B, and the projecting apparatus 10B may supply the image to be projected by each projecting apparatus to each of the projecting apparatus 10A and the projecting apparatus 10C. In this case, the projecting system 1 may not necessarily include the image supply apparatus 20.

In the example illustrated in FIG. 1, the projecting apparatus 10A projects a projection image PI1 onto the projection surface SC. The projection image PI1 is an example of a “first projection image”. The projecting apparatus 10B projects a projection image PI2 onto the projection surface SC. The projection image PI2 is an example of a “projection image”. The projecting apparatus 10C projects a projection image PI3 onto the projection surface SC. The projection image PI3 is an example of a “second projection image”. The projection image PI1, the projection image PI2, and the projection image PI3 are projected so as to partially overlap each other on the projection surface SC, whereby one projection image PI_A is displayed as a whole onto the projection surface SC.

Specifically, the projection image PI1 includes a portion PT1 and a portion PT2. The projection image PI2 includes a portion PT3, a portion PT4, and a portion PT5. The projection image PI3 includes a portion PT6 and a portion PT7. The portion PT1 of the projection image PI1 and the portion PT3 of the projection image PI2 are projected on the projection surface SC in an overlapping manner. Further, the portion PT5 of the projection image PI2 and the portion PT6 of the projection image PI3 are projected on the projection surface SC in an overlapping manner.

As a result, an area RL1 of the projection image PI_A includes the portion PT1 of the projection image PI1 and the portion PT3 of the projection image PI2. The area RL1 is an example of a “first area”. An area RL2 of the projection image PI_A includes only the portion PT2 of the projection image PI1. An area RL3 of the projection image PI_A includes only the portion PT4 of the projection image PI2. The area RL3 is an example of a “third area”. An area RL4 of the projection image PI_A includes the portion PT5 of the projection image PI2 and the portion PT6 of the projection image PI3. The area RL4 is an example of a “second area”. An area RL5 of the projection image PI_A includes the portion PT7 of the projection image PI3.

Among the plurality of areas RL of the projection image PI_A, the area RL1 and the area RL4 are overlapping areas DR. Further, the area RL2, the area RL3, and the area RL5 are non-overlapping areas NR.

In the present embodiment, in a state in which multi-projection is performed by the projecting apparatus 10A, the projecting apparatus 10B, and the projecting apparatus 10C, brightness of the area RL1 is different from brightness of the area RL4.

### 1-1-2: Configuration of Projecting Apparatus

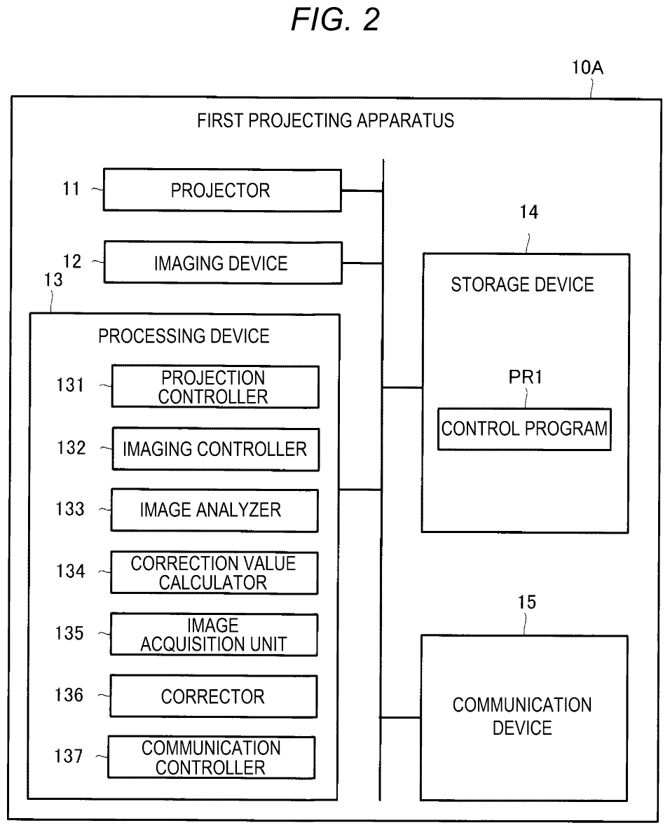

FIG. 2 is a block diagram of the projecting apparatus 10A. The projecting apparatus 10B and the projecting apparatus 10C may have the same configuration as the projecting apparatus 10A. Alternatively, the projecting apparatus 10B and the projecting apparatus 10C may have a configuration in which at least one of an imaging device 12, an imaging controller 132, an image analyzer 133, a correction value calculator 134, an image acquisition unit 135, and a corrector 136, which will be described later, is not provided while having a configuration essential as a projecting apparatus.

The projecting apparatus 10A includes a projector 11, the imaging device 12, the processing device 13, the storage device 14, and a communication device 15.

The elements of the projecting apparatus 10A are coupled to each other via a single bus or multiple buses for information communication. The elements of the projecting apparatus 10A may be configured with one or more instruments, and some elements of the projecting apparatus 10A may be omitted.

The projector 11 is a device that projects various projection images PI onto the projection surface SC such as a screen or a wall. The projector 11 projects various projection images PI under a control of the processing device 13. The projector 11 includes, for example, a light source, a projecting lens, a dichroic mirror, a prism, and a liquid crystal panel, modulates light from the light source using the liquid crystal panel, and projects the modulated light onto the projection surface SC via the projecting lens. The light source, the projecting lens, the dichroic mirror, and the prism are examples of a projection optical system.

The imaging device 12 is a device that captures the projection image PI projected onto the projection surface SC. The imaging device 12 captures various images under the control of the processing device 13. The imaging device 12 is, for example, an image sensor. The imaging device 12 is an example of a “sensor”.

The processing device 13 is a processor that performs an overall control of the projecting apparatus 10A and is configured with, for example, a single chip or a plurality of chips. The processing device 13 is configured, for example, with a central processing unit (CPU) including an interface with a peripheral apparatus, an arithmetic device, a register, and so on. A part or all of the functions of the processing device 13 may be implemented by hardware such as a digital signal processor (DSP), an application-specific integrated circuit (ASIC), a programmable logic device (PLD), or a field-programmable gate array (FPGA). The processing device 13 may include a system on chip (SoC). The processing device 13 performs various types of processing in parallel or in sequence.

The storage device 14 is a recording medium readable by the processing device 13, and stores a plurality of programs including a control program PRI to be executed by the processing device 13. Further, the storage device 14 stores a pattern image for measurement projected from the projector 11 at the time of correction to be described later. Hereinafter, the pattern image for measurement may be referred to as a measurement pattern. The storage device 14 may be configured, for example, with at least one of a read only memory (ROM), an erasable programmable ROM (EPROM), an electrically erasable programmable ROM (EEPROM), and a random access memory (RAM). The storage device 14 may be called a register, a cache, a main memory, a main storage device, or the like.

The communication apparatus 15 is hardware serving as a transmitting and receiving device for communicating with other devices. The communication device 15 is also called, for example, a network device, a network controller, a network card, or a communication module or the like. The communication device 15 may include a connector for wired connection and an interface circuit compatible with the above connector. Further, the communication device 15 may include a wireless communication interface. Examples of the connector and the interface circuit for wired connection include those compliant with wired local area network (LAN), IEEE 1394, and a universal serial bus (USB). Further, examples of the wireless communication interface include an interface compliant with wireless LAN and Bluetooth (registered trademark).

The processing device 13 functions as a projection controller 131, the imaging controller 132, the image analyzer 133, the correction value calculator 134, the image acquisition unit 135, the corrector 136, and a communication controller 137 by reading and executing the control program PRI from the storage device 14. Note that the control program PRI may be transmitted from another apparatus such as a server that manages the projecting apparatus 10A via a communication network.

The projection controller 131 causes the projector 11 to project the measurement pattern described above onto the projection surface SC. Further, the projection controller 131 causes the projector 11 to project the image acquired from the image supply apparatus 20 by the image acquisition unit 135 to be described later onto the projection surface SC.

The imaging controller 132 causes the imaging device 12 to capture an image of the reflected light of the measurement pattern projected onto the projection surface SC.

The image analyzer 133 analyzes the reflected light of the measurement pattern imaged by the imaging device 12 and calculates a measured value indicating a color of the measurement pattern in a captured image.

The correction value calculator 134 calculates a correction value to be set in the corrector 136 to be described later based on the measured value calculated by the image analyzer 133. The correction value is an example of “correction data”.

Hereinafter, the measurement pattern projected by the projection controller 131 in the present embodiment will be described.

As an example, a projecting apparatus having a normal color adjustment function divides colors from the lowest gradation on a black side to the highest gradation on a white side substantially equally, projects colored light having the color of the gradation at each division point, and calculates a correction value based on an imaging result obtained by imaging the colored light projected onto the projection surface. At this time, the projecting apparatus estimates a color of an intermediate gradation between a gradation of first colored light and a gradation of second colored light based on an interpolation operation such as spline interpolation, and calculates the correction value based on the estimated result.

Alternatively, as another example, a projecting apparatus having a normal color adjustment function projects colored light having a color based on gray of the intermediate gradation and calculates a correction value based on an imaging result obtained by imaging the colored light projected onto the projection surface. In this case, colors other than gray are estimated based on the interpolation operation using a property of the additive color mixture, and the correction value is calculated based on the estimated result.

However, since the colored light on the low gradation side close to black with a gradation of zero is the colored light obtained by gradually adding RGB modulated light to the colored light output from the liquid crystal panel having black with a gradation of zero, that is, when a transmittance of the liquid crystal panel is zero, there is a problem that a change in a chromaticity u′v′ is large and an estimation error is large in a measurement method of the related art. Specifically, when the transmittance of the liquid crystal panel increases from a state in which the gradation of the liquid crystal panel is zero, a ratio between RGB modulated light components, that is, R light, G light, and B light, tend to change greatly. This change in the ratio causes a change in the chromaticity u′v′. The unevenness of the chromaticity u′v′ caused when the transmittance of the liquid crystal panel is 0 is caused by, for example, color unevenness of the projection optical system. The color unevenness of the projection optical system is caused by, for example, chromatic aberration of the projecting lens and manufacturing accuracy of the prism.

In a normal projecting apparatus, as an example, since an input/output characteristic is adjusted to γ=2.2, a change in an amount of light when the gradation changes is small in the vicinity of the gradation 0. Therefore, in order to correct the black color unevenness, it is necessary to increase an output gradation (correction value) after the correction to a gradation at which the change in the amount of light when the gradation changes can be secured to some extent. Noted that the “output gradation” means the gradation of the colored light projected onto the projection surface SC, and means the gradation output from the corrector 136 to be described later to the projector 11.

In order to correct the “black floating” which is the difference in brightness between the overlapping area DR and the non-overlapping area NR, it is necessary to increase the output gradation (correction value) after the correction so that the brightness of the non-overlapping area NR is the same as the brightness of the overlapping area DR.

As in the related art, when black colored light with the gradation 0 is projected onto the projection surface SC as a reference projection light, the imaging result of the reflected light reflected by the projection surface SC is analyzed, and the measured value is calculated, the gradation separated from the gradation after the correction is measured, and thus an interpolation error increases. As a result, there is a problem that a highly accurate correction value cannot be calculated. In short, as an example, when black is corrected using projection light of each gradation obtained by dividing a gradation width from the gradation 0 to the gradation 1023 into eight equal parts, there is a problem that the interpolation error increases.

Since the projection light on the low gradation side close to black has a low luminance, an influence of a dark current noise, an optical shot noise, and the like increases. Therefore, when the colored light of the monochromatic light of R, G, and B is projected onto the projection surface for each projecting apparatus, and the measured value is calculated by analyzing the imaging result of the reflected light from the projection surface, there is a problem that an error included in the measured value increases.

Therefore, in the present embodiment, the projection light on the low gradation side close to black projected as the measurement pattern is projection light of a plurality of gradations.

The gradation of the measurement pattern for the overlapping area DR is set to three or more gradations including a lower gradation and a higher gradation than an expected gradation which is an output gradation corresponding to an output luminance expected after color unevenness correction. The reason why the gradation of the measurement pattern for the overlapping area DR is set to three gradations or more is that at least three gradations are required for curve fitting in consideration of γ=2.2 which is the input/output characteristic. As an example, these three gradations are a gradation A, a gradation B, and a gradation C (A<B<C). The projecting apparatus 10A according to the present embodiment can measure the gradation necessary for correcting the color unevenness on the low gradation side close to black in detail by setting the gradation of the measurement pattern for the overlapping area DR to three gradations or more.

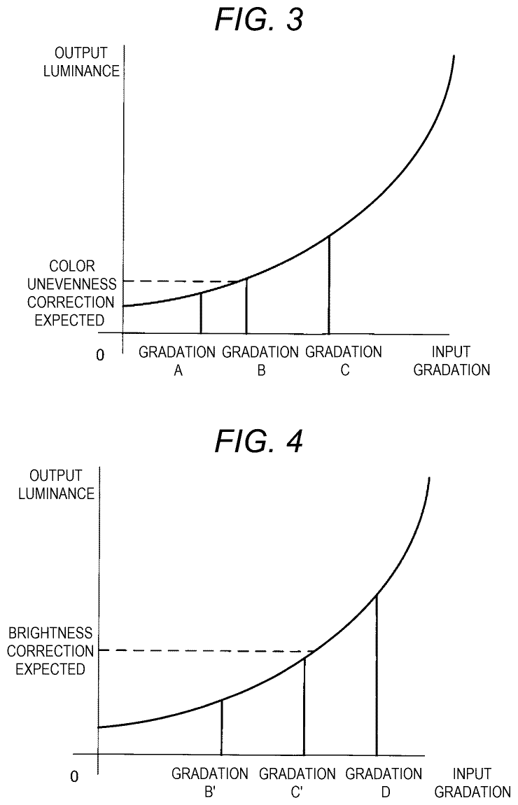

FIG. 3 is a graph illustrating a γ curve corresponding to a relationship between the input gradation and the output luminance in the overlapping area DR.

As illustrated in FIG. 3, the gradation A is a gradation lower than the expected gradation, which is the output gradation corresponding to the output luminance expected after the color unevenness correction. Further, the gradation C is a gradation higher than the expected gradation, which is the output gradation corresponding to the output luminance expected after the color unevenness correction. The gradation B is a gradation between the gradation A and the gradation C.

As described above, in the gradation close to black having the gradation of zero, as illustrated in FIG. 3, even a small change in the output luminance results in a large change in chromaticity. Therefore, when the colored light having the gradation lower than the gradation A is used as the projection light, the correction error increases. Therefore, it is preferable to perform correction after making the black color brighter until the output luminance at which the γ curve has a certain degree of inclination is obtained. The expected gradation corresponding to the output luminance at which the γ curve has a certain degree of inclination is determined in advance. The projecting apparatus 10A according to the present embodiment measures the output gradation of at least three gradations including the gradation B, which is an intermediate gradation, in order to improve the accuracy of fitting when curve interpolation is performed using a γ curve between the gradation A, which is the gradation lower than the expected gradation to some extent, and the gradation C, which is the gradation higher than the expected gradation to some extent.

The expected gradation is determined in advance depending on a degree of the color unevenness that originally exists in the projecting apparatus 10. For example, when the color unevenness can be prevented by slight adjustment, the expected gradation is a low gradation. Meanwhile, for example, when the color unevenness is large due to quality of the component used in the projecting apparatus, the expected gradation is set to a high gradation in order to secure the minimum adjustment range.

The gradation A can be determined based on the fact that the amount of light changes sufficiently when the gradation changes by one step. “The amount of light changes sufficiently” means that, for example, when the image analyzer 133 analyzes the imaging result of the measurement pattern before the gradation changes by one step and the imaging result of the measurement pattern after the gradation changes by one step, the amount of light changes to such an extent that the image analyzer 133 can detect a difference in light amount between the two that is greater than or equal to a predetermined value. As an example, the gradation A is set based on the fact that a color difference Δu′v′ becomes about 1/1000 when the gradation is changed by one step. For example, in the case of a projecting apparatus having a contrast ratio of 2000:1, the gradation A is a gradation of 20 or more when the maximum value of the gradation is 1023. In the case of a projecting apparatus having a contrast ratio of 3000:1, the gradation A is a gradation of 15 or more when the maximum value of the gradation is 1023.

The gradation C is a gradation equal to or smaller than the maximum value of 127 of a first divided gradation width obtained by dividing the gradation width from the gradation 0 to the gradation 1023 into eight. The gradation C may be a gradation equal to or smaller than the minimum value 128 of a second divided gradation width obtained by dividing the gradation width from the gradation 0 to the gradation 1023 into eight.

As a result, a difference value between the gradation A and the gradation B is smaller than a difference value between the highest gradation and a second highest gradation among the plurality of input gradations up to 1023 gradations. Here, as an example, the “highest gradation” is the highest gradation 1023 in an eighth divided gradation width obtained by dividing the gradation width from the gradation 0 to the gradation 1023 into eight. The “second highest gradation” is, for example, the lowest gradation 896 in the eighth divided gradation width obtained by dividing the gradation width from the gradation 0 to the gradation 1023 into eight.

In the present embodiment, the gradation width from the gradation 0 to the gradation 1023 is divided into eight sections, but is not particularly limited. For example, the gradation width from the gradation 0 to the gradation 1023 may be divided into seven sections or nine sections. When the gradation width from the gradation 0 to the gradation 1023 is divided into seven sections, for example, the maximum value of the first divided gradation width is 146, and the gradation C may be a gradation of 146 or less.

The gradation of the measurement pattern for the non-overlapping area NR is set to three or more gradations including a lower gradation and a higher gradation than an expected gradation which is an output gradation corresponding to an output luminance expected after “black floating” is corrected. The reason why the gradation of the measurement pattern for the non-overlapping area NR is set to three gradations or more is that at least three gradations are required for curve fitting in consideration of γ=2.2 which is the input/output characteristic. As an example, these three gradations are a gradation B′, a gradation C′, and a gradation D (B′<C′<D). The projecting apparatus 10A according to the present embodiment can measure the gradation necessary for the correction of “black floating” on the low gradation side close to black in detail by setting the gradation of the measurement pattern for the non-overlapping area NR to three gradations or more. The expected gradation is determined in advance by, for example, experiments or simulations.

FIG. 4 is a graph illustrating a γ curve corresponding to a relationship between the input gradation and the output luminance in the non-overlapping area NR.

As illustrated in FIG. 4, the gradation B′ is a gradation lower than the expected gradation, which the output gradation corresponding to the output luminance expected after the “black floating” is corrected. Further, the gradation D is a gradation higher than the expected gradation, which is the output gradation corresponding to the output luminance expected after the “black floating” is corrected. The gradation C′ is a gradation between the gradation B′ and the gradation D.

A difference value between the gradation B′ and the gradation C′ is smaller than the difference value between the highest gradation and the second highest gradation among the plurality of input gradations up to 1023 gradations. Here, as an example, the “highest gradation” is the highest gradation 1023 in an eighth divided gradation width obtained by dividing the gradation width from the gradation 0 to the gradation 1023 into eight. The “second highest gradation” is, for example, the lowest gradation 896 in the eighth divided gradation width obtained by dividing the gradation width from the gradation 0 to the gradation 1023 into eight.

The gradation B′ illustrated in FIG. 4 is higher than the gradation A illustrated in FIG. 3. In the overlapping area DR, since the projection light from the two projecting apparatuses 10 overlaps, the brightness of the projection image PI in the overlapping area DR is brightness of the two projecting apparatuses 10. In order to correct the “black floating”, it is necessary to project the projection light with a higher gradation to the non-overlapping area NR than to the overlapping area DR, and thus the gradation B′ needs to be higher than the gradation A.

When colored light with a bright gradation is projected in the overlapping area DR beyond a range in which color unevenness can be minimized, the overall contrast ratio deteriorates. For this reason, it is preferable to project the projection light having the gradation within a range in which the color unevenness can be minimized in the overlapping area DR.

By making the gradation B and the gradation B′ equal to each other and making the gradation C and the gradation C′ equal to each other among the gradation A, the gradation B, and the gradation C in FIG. 3 and the gradation B′, the gradation C′, and the gradation D in FIG. 4, a part of the measurement pattern can be shared by the correction related to the overlapping area DR and the correction related to the non-overlapping area NR.

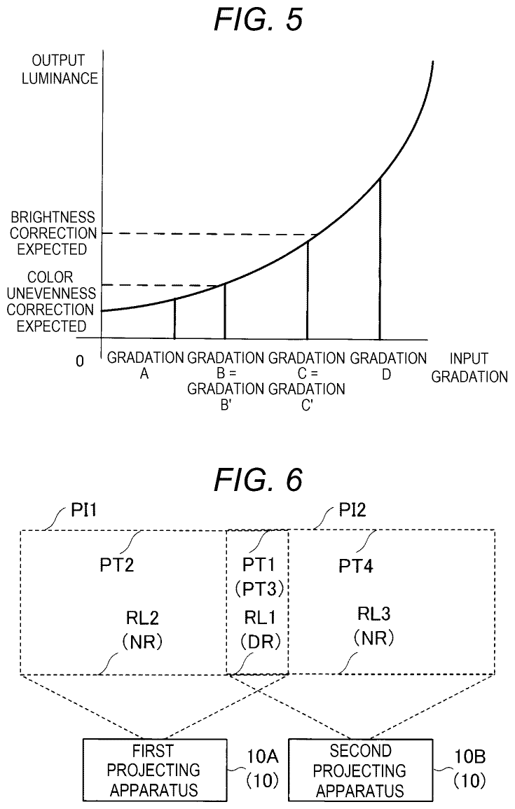

FIG. 5 is a graph illustrating a γ curve corresponding to a relationship between the input gradation and the output luminance in the overlapping area DR and the non-overlapping area NR.

Specifically, the projection controller 131 may project measurement patterns of at least four gradations of the gradation A, the gradation B=the gradation B′, the gradation C=the gradation C′, and the gradation D onto the overlapping area DR and the non-overlapping area NR, and the image analyzer 133 may analyze the pattern image for measurement captured by the imaging device 12 to calculate the measured value. The projection controller 131 may further project the measurement pattern of the gradation 0 onto the overlapping area DR and the non-overlapping area NR, and the image analyzer 133 may analyze the pattern image for measurement captured by the imaging device 12 to calculate the measured value.

As a result, it is possible to reduce the number of measurement patterns and shorten a measurement time.

In order to increase the luminance of the measurement pattern, it is preferable that the measurement pattern is a color obtained by changing one color component among color components of a R component, a G component, and a B component based on a reference gray instead of a single color among the R component, the G component, and the B component. The R component is an example of a “first color component”. The G component is an example of a “second color component”. The B component is an example of a “third color component”. In this case, the reference gray is preferably gray in which all of the R component, the G component, and the B component become the gradation B close to the output gradation after the color unevenness correction of the overlapping area DR. As a result, the gradation of the measurement pattern becomes the following ten patterns. Hereinafter, for convenience of description, values of the R component, the G component, and the B component of the measurement pattern 1 to the measurement pattern 10 are denoted by r, g, and b, respectively. r is an example of a “first gradation value”. g is an example of a “second gradation value”. b is an example of a “third gradation value”.
Measurement pattern 1: (r, g, b)=(D, B, B)
Measurement pattern 2: (r, g, b)=(B, D, B)
Measurement pattern 3: (r, g, b)=(B, B, D)
Measurement pattern 4: (r, g, b)=(C, B, B)
Measurement pattern 5: (r, g, b)=(B, C, B)
Measurement pattern 6: (r, g, b)=(B, B, C)
Measurement pattern 7: (r, g, b)=(B, B, B)
Measurement pattern 8: (r, g, b)=(A, B, B)
Measurement pattern 9: (r, g, b)=(B, A, B)
Measurement pattern 10: (r, g, b)=(B, B, A)

When the measurement pattern includes the gradation 0, it is preferable to further use the following measurement patterns.
Measurement pattern 11: (r, g, b)=(0, B, B)
Measurement pattern 12: (r, g, b)=(B, 0, B)
Measurement pattern 13: (r, g, b)=(B, B, 0)

The combination of (r, g, b) of the measurement patterns projected from the projector 11 onto the projection surface SC is an example of “gradation data”.

The projecting apparatus 10A projects, as the projection image PI1, a plurality of types of colored light corresponding one-to-one to the plurality of pieces of gradation data on the projection surface SC. The colored light projected by the projecting apparatus 10A is an example of the “first colored light”.

The projecting apparatus 10B projects, as the projection image PI2, a plurality of types of colored light corresponding one-to-one to the plurality of pieces of gradation data on the projection surface SC. The colored light projected by the projecting apparatus 10B is an example of the “second colored light”.

The projecting apparatus 10C projects, as the projection image PI3, a plurality of types of colored light corresponding one-to-one to the plurality of pieces of gradation data on the projection surface SC. The colored light projected by the projecting apparatus 10C is an example of “third colored light”.

By using the above measurement pattern, it is possible to brighten the measurement pattern, improve an S/N ratio of the imaging device 12, and reduce an error of the measured value.

In a method of the related art, as an example, when the R component among the R component, the G component, and the B component is corrected, a measurement pattern in which only the liquid crystal panel corresponding to the R component among the liquid crystal panels is driven and black with the gradation 0 is output from the liquid crystal panels corresponding to the G component and the B component may be used. In the present embodiment, for the purpose of improving the S/N ratio, in order to brighten the measurement pattern, a measurement pattern with an increased R component, a measurement pattern with a decreased R component, a measurement pattern with an increased G component, a measurement pattern with a decreased G component, a measurement pattern with an increased B component, and a measurement pattern with a decreased B component are used from a gray pattern in which all of the R component, the G component, and the B component are at the gradation B.

FIG. 6 is a diagram illustrating a projecting method for a measurement pattern by the projecting apparatus 10A.

To simplify the description, in FIG. 6, the same elements as those in FIG. 1 are denoted by the same reference numerals. On the other hand, in FIG. 6, unlike FIG. 1, only the projection image PI1 projected from the projecting apparatus 10A and the projection image PI2 projected from the projecting apparatus 10B are illustrated, and the projection image PI3 projected from the projecting apparatus 10C is omitted. Further, in FIG. 6, since the projection image PI3 is omitted, the projection image PI2 accordingly has only the portion PT1 and the portion PT4, and does not have the portion PT5. Accordingly, the projection image PI2 includes the area RL1 and the area RL3, but does not include the area RL4.

In FIG. 6, the projection image PI1 projected by the projecting apparatus 10A and the projection image PI2 projected by the projecting apparatus 10B have the same measurement pattern. As an example, both the projection image PI1 and the projection image PI2 are the measurement pattern 1 described above. However, both the projection image PIL and the projection image PI2 are not limited to the measurement pattern 1, and both may be any of the measurement pattern 2 to the measurement pattern 13.

The projection of the projection image PI1 by the projecting apparatus 10A and the projection of the projection image PI2 by the projecting apparatus 10B are synchronized. That is, the projection image PI2 is projected at the same timing as the projection image PI1.

By projecting the projection image PI by the projecting method described above, the S/N ratio of the imaging device 12 is improved by making the brightness of the overlapping area DR twice or more as compared with the case where the measurement pattern is projected by one projecting apparatus 10. As a result, the projecting apparatus 10A according to the present embodiment can prevent the error of the measured value calculated by the image analyzer 133. In addition, in each measurement pattern, since the gradation of any of the R component, the G component, and the B component is not zero, it is possible to reduce the error of the measured value using the imaging device 12.

In a projecting method for measurement patterns from a plurality of projecting apparatuses of the related art, for example, one projecting apparatus projects colored light having a non-zero gradation as a measurement pattern, and the other projecting apparatuses project a black measurement pattern having the gradation 0. In this case, the brightness of the overlapping area DR is half or less that of the present embodiment. Meanwhile, in the projecting system 1 according to the present embodiment, in order to set the S/N ratio of the imaging device 12 to a good state, all the projecting apparatuses 10 simultaneously project colored light of the same color as a measurement pattern. As a result, the measurement pattern becomes twice or more brighter than the projecting method of the related art in which the colored light is projected as the measurement pattern from only one projecting apparatus.

In the projecting method for measurement patterns from a plurality of projecting apparatuses, as another example, it is conceivable to calculate a first measured value by projecting colored light as a measurement pattern from only one projecting apparatus and capturing an image of the projected measurement pattern, and then calculate a second measured value by projecting colored light as a measurement pattern from another projecting apparatus and capturing an image of the projected measurement pattern. In this case, the first measured value and the second measured value are added up, but due to the error of the first measured value and the error of the second measured value, the error is doubled as a result of adding up the first measured value and the second measured value. Specifically, since the S/N ratio is deteriorated by measuring light having half the brightness, a standard deviation of the error becomes √2 times, and adding together two measured values results in the two errors being added together, which results in the standard deviation of the error becoming √2 times. As a result, the final standard deviation of the error is twice the product of √2 times and √2 times. As a result, the noise in the S/N ratio is doubled. Meanwhile, in the present embodiment, since the measurement is performed only once, the noise in the S/N ratio becomes small.

In the above description, as an example, the effect when the liquid crystal panel provided in the projector 11 includes three panels of the panel corresponding to the R component, the panel corresponding to the G component, and the panel corresponding to the B component has been described. However, the same effect can be obtained when the liquid crystal panel includes only one panel. This is because the S/N ratio is improved as the light incident on the imaging device 12 as an image sensor is brighter.

In the present embodiment, the measurement pattern projected by the projection controller 131 has been described above.

A specific example of a calculation method for the correction value by the correction value calculator 134 will be described later in the description of the operation of the present embodiment with reference to FIGS. 8 to 35.

In FIG. 2, the image acquisition unit 135 acquires an image to be projected from the image supply apparatus 20.

The corrector 136 corrects the image acquired by the image acquisition unit 135 using the correction value calculated by the correction value calculator 134.

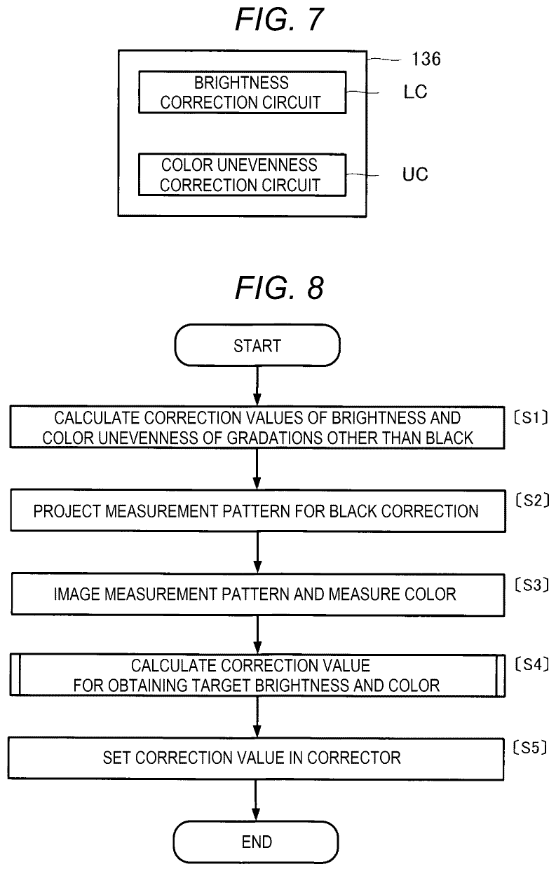

FIG. 7 is a functional block diagram of the corrector 136. The corrector 136 includes a brightness correction circuit LC and a color unevenness correction circuit UC.

The brightness correction circuit LC corrects the brightness of the image acquired by the image acquisition unit 135 using the correction value calculated by the correction value calculator 134. The correction includes the correction of “black floating” described above.

The color unevenness correction circuit UC corrects the color unevenness of the image acquired by the image acquisition unit 135 using the correction value calculated by the correction value calculator 134.

In FIG. 2, the projection controller 131 causes the projector 11 to project the image corrected by the corrector 136 as the projection image PI onto the projection surface SC.

The communication controller 137 causes the communication device 15 to transmit and receive various information to and from an external device. The various information include the correction values transmitted from the projecting apparatus 10A to each of the projecting apparatus 10B and the projecting apparatus 10C.

### 1-2: Operation in First Embodiment

FIG. 8 is a flowchart illustrating an operation example of the projecting apparatus 10A according to the first embodiment.

In step S1, the projecting apparatus 10A calculates a correction value of the brightness and a correction value of the color unevenness for gradations other than black. Further, the projecting apparatus 10A uses the correction values to adjust the brightness and the color of the projection images PI from the projecting apparatuses 10A to 10C to be uniform among the projecting apparatuses 10.

The “black” here is, for example, a color included in the first gradation width including the gradation 0 when the gradation width from the gradation 0 which is the minimum gradation value to the gradation 1023 which is the maximum gradation value is divided into N parts. Here, N is an integer of three or more. Hereinafter, for convenience of description, N=8 may be used.

The correction of the brightness described above is a correction for reducing the difference in brightness between the overlapping area DR and the non-overlapping area NR for the gradations other than black. The method used for correcting the color unevenness and the brightness may be a method of the related art. As an example, the method may be a method of correcting the brightness and the color unevenness by setting one of areas RL1 to RL5 in FIG. 1 as a target area, and comparing an imaging value indicated by an imaging value obtained by imaging the target area with an imaging value obtained by imaging another area RL.

At this time, it is assumed that adjustment points when the processing device 13 functions as the color unevenness correction circuit UC to correct the projection image PI are lattice points LP of 11 rows×21 columns in the projection image PI as an example. The number of gradations is based on a boundary gradation obtained by dividing the gradation width from the gradation 0 to the gradation 1023 into eight equal parts.

In the process of step S1, the processing device 13 determines whether each of the lattice points LP used as the color unevenness correction circuit UC is provided in the overlapping area DR or the non-overlapping area NR. For example, before step S1, the processing device 13 projects an all-white image as a projection image only from the projector 11, and the imaging device 12 of the projecting apparatus 10A captures the all-white image. Next, only the projecting apparatus 10B projects an all-white image as a projection image, and the imaging device 12 of the projecting apparatus 10A captures the all-white image. From these imaging results, a position of a right side of the all-white image projected from the projecting apparatus 10A and a position of a left side of the all-white image projected from the projecting apparatus 10B are detected, and an area from the position of the right side to the position of the left side is determined as the overlapping area DR in a coordinate system of the captured image. Then, based on a correspondence relationship among the coordinate system of the projecting apparatus 10A, the coordinate system of the projecting apparatus 10B, and the coordinate system of the captured image generated before step S1, the overlapping area DR in the coordinate system of the captured image is converted into the overlapping area DR in the coordinate system of the projecting apparatus 10A and the coordinate system of the projecting apparatus 10B. The processing device 13 determines whether each of the lattice points LP belongs to the overlapping area DR in the coordinate system of the projecting apparatus 10A and the coordinate system of the projecting apparatus 10B based on the captured images of the lattice points LP. The correspondence relationship can be calculated by, for example, a well-known calibration technique using a gray code. The coordinate system of the projecting apparatus 10A is a two-dimensional coordinate system of a liquid crystal panel. The same applies to the coordinate system of the projecting apparatus 10B. The same applies to the projecting apparatus 10B and the projecting apparatus 10C.

The above process is merely an example, and the method of determining whether each of the lattice points LP is provided in the overlapping area DR or the non-overlapping area NR can be changed as appropriate.

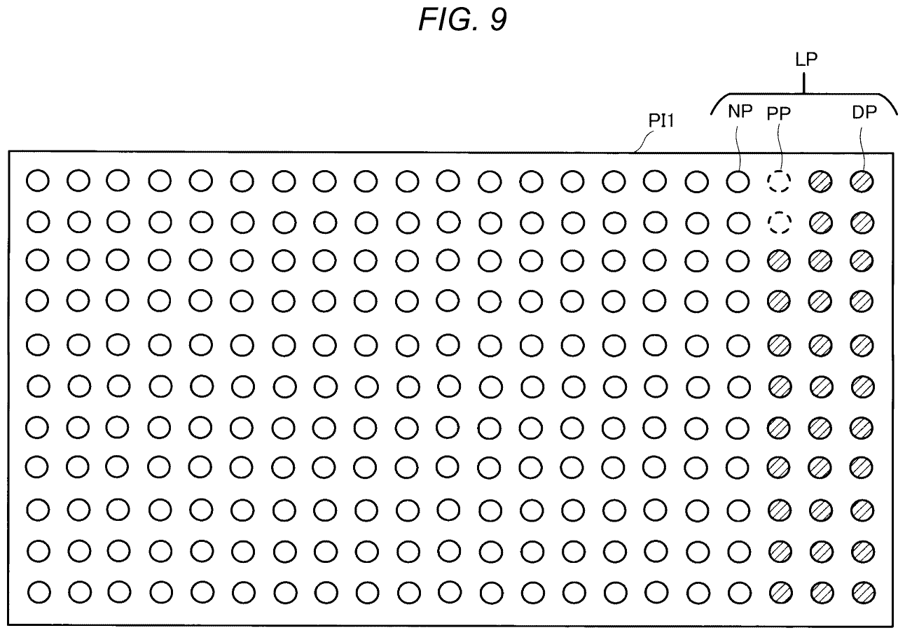

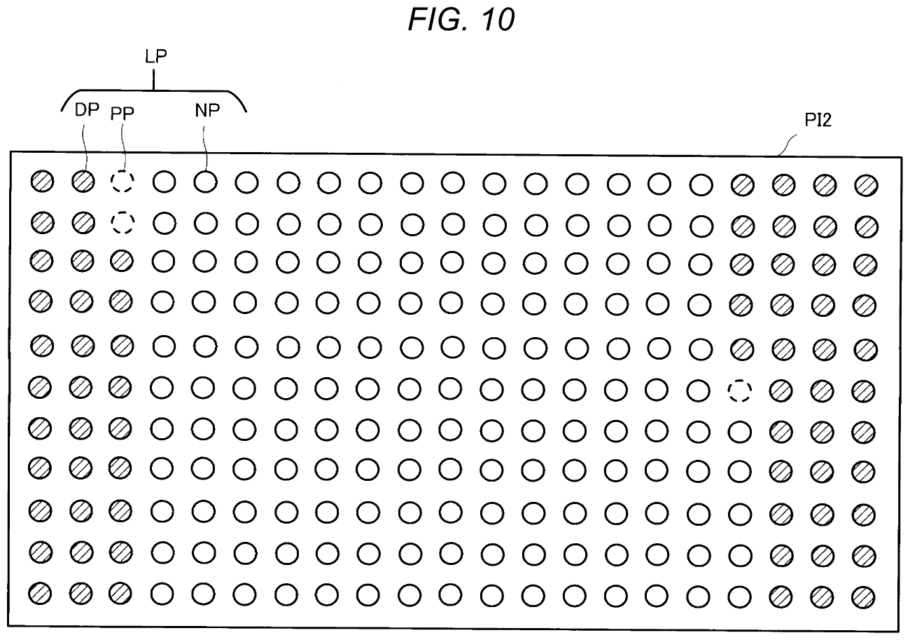

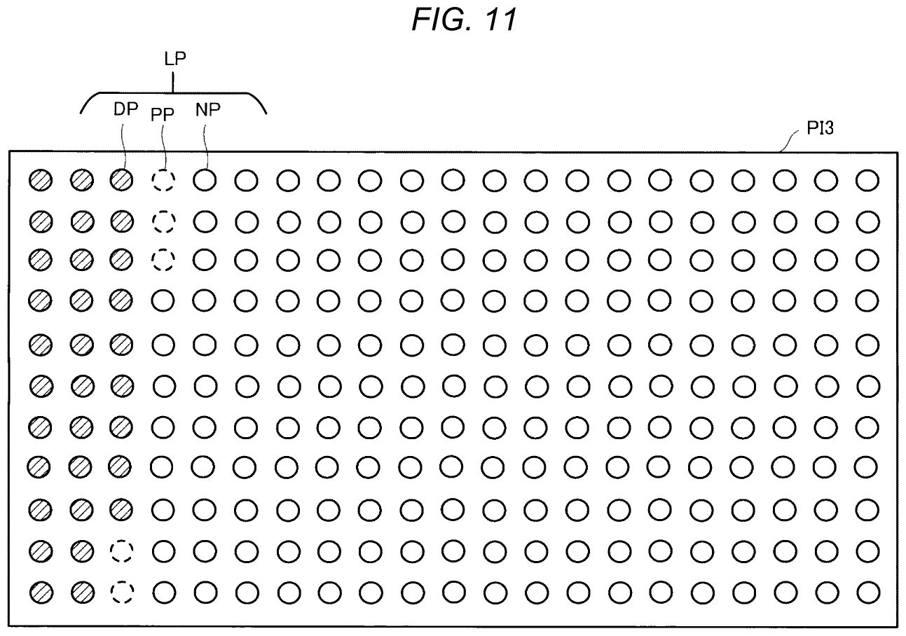

FIGS. 9 to 11 are diagrams illustrating examples of the lattice points LP. More specifically, FIG. 9 illustrates an example of the lattice points LP corresponding to the projection image PI1 projected from the projecting apparatus 10A. FIG. 10 illustrates an example of the lattice points LP corresponding to the projection image PI2 projected from the projecting apparatus 10B. FIG. 11 illustrates an example of the lattice points LP corresponding to the projection image PI3 projected from the projecting apparatus 10C.

In FIGS. 9 to 11, the lattice points LP include lattice points DP, lattice points NP, and lattice points PP. In these drawings, hatched circles indicate the lattice points DP provided in the overlapping area DR. White circles indicate the lattice points NP provided in the non-overlapping area NR. A circle with a dotted contour indicates a lattice point PP for which it is not possible to determine whether it is provided in the overlapping area DR or the non-overlapping area NR. There is a measured value calculated by the image analyzer 133 for each lattice point LP illustrated in FIGS. 9 to 11.

In step S2, the projecting apparatus 10A projects a measurement pattern black correction. Specifically, the processing device 13 provided in the projecting apparatus 10A functions as the projection controller 131. The processing device 13 reads the measurement pattern from the storage device 14 and causes the projector 11 to sequentially project the measurement pattern onto the projection surface SC.

The measurement pattern is any of the measurement patterns 1 to 13. As described above, these measurement patterns are measurement patterns in which the gradation of one of the R component, the G component, and the B component is changed with reference to gray in which all of the R component, the G component, and the B component are at the gradation B.

In the following description, as an example, in the first measurement pattern used for correction of the black color unevenness in the overlapping area DR, the gradation A is a gradation 22, the gradation B is a gradation 34, and the gradation C is a gradation 60.

Further, in the second measurement pattern used for the correction of “black floating” in the non-overlapping area NR and the correction of the black color unevenness, it is assumed that the gradation B′=the gradation B is a gradation 34, the gradation C′=the gradation C is a gradation 60, and the gradation D is a gradation 95.

In step S3, the processing device 13 provided in the projecting apparatus 10A functions as the imaging controller 132. The processing device 13 causes the imaging device 12 to capture an image of each measurement pattern projected onto the projection surface SC. The processing device 13 functions as the image analyzer 133. The processing device 13 analyzes the measurement pattern imaged by the imaging device 12 and calculates a measured value indicating the color of the measurement pattern in the captured image.

First, the processing device 13 obtains the correspondence relationship between the gradation values (r, g, b) (0≤r, g, b≤95) of the colored light as the measurement pattern projected by the projector 11 and the measured values (R, G, B) representing the color of the colored light in the captured image calculated by analyzing the colored light as the measurement pattern captured by the imaging device 12 at each point of the lattice point LP by the interpolation operation.

As described above, the gradation values of the R component, the G component, and the B component of the colored light projected by the projector 11 are, for example, five gradations from the gradation 0 to the gradation 95.

Here, the gradation values (r, g, b) are an example of “gradation data”. Further, the “measured values (R, G, B)” are an example of “measurement data”. The measurement data includes brightness values indicating the brightness of the reflected light of the colored light corresponding to the R component, the G component, and the B component.

Hereinafter, in order to make the notation easy to understand, the R component, the G component, and the B component of the measured values (R, G, B) representing the color of the colored light in the captured image calculated by the processing device 13 when the colored light of the gradation values (r, g, b) is projected as the measurement pattern by the projector 11 are denoted by R_{(r, g, b)}, G_{(r, g, b)}, and B_{(r, g, b)}, respectively.

When the R component, the G component, and the B component of the measured value indicating the color of the colored light in the captured image are collectively expressed, they are denoted as (R, G, B)_{(r, g, b)}=(R_{(r, g, b)}, G(r, g, b), B_{(r, g, b)}.

Among the gradation values (r, g, b) of the colored light as the measurement patterns, the measured values of the five measurement patterns in which only the R component is changed are expressed by the following Formulas 1 to 5.

$${( R , G , B )}_{( 0 , 34 , 34 )} = ( {R}_{( 0 , 34 , 34 )} , {G}_{( 0 , 34 , 34 )} , {B}_{( 0 , 34 , 34 )} ) \qquad [ 1 ]$$

$${( R , G , B )}_{( 22 , 34 , 34 )} = ( {R}_{( 22 , 34 , 34 )} , {G}_{( 22 , 34 , 34 )} , {B}_{( 22 , 34 , 34 )} ) \qquad [ 2 ]$$

$${( R , G , B )}_{( 34 , 34 , 34 )} = ( {R}_{( 34 , 34 , 34 )} , {G}_{( 34 , 34 , 34 )} , {B}_{( 34 , 34 , 34 )} ) \qquad [ 3 ]$$

$${( R , G , B )}_{( 60 , 34 , 34 )} = ( {R}_{( 60 , 34 , 34 )} , {G}_{( 60 , 34 , 34 )} , {B}_{( 60 , 34 , 34 )} ) \qquad [ 4 ]$$

$${( R , G , B )}_{( 95 , 34 , 34 )} = ( {R}_{( 95 , 34 , 34 )} , {G}_{( 95 , 34 , 34 )} , {B}_{( 95 , 34 , 34 )} ) \qquad [ 5 ]$$

The measured values of these five measurement patterns are all known. Therefore, the processing device 13 can perform curve interpolation between the measured values of the R component among the measured values (R, G, B). The same applies to the G component and the B component. As the curve interpolation method, a known method can be used. For example, the processing device 13 may perform curve interpolation using a spline curve. Alternatively, the processing device 13 may perform parabolic interpolation using three points out of five points corresponding to five measured values. Alternatively, the processing device 13 may execute cubic curve interpolation using four points out of five points corresponding to the five measured values. An example of the cubic curve interpolation is cubic interpolation.

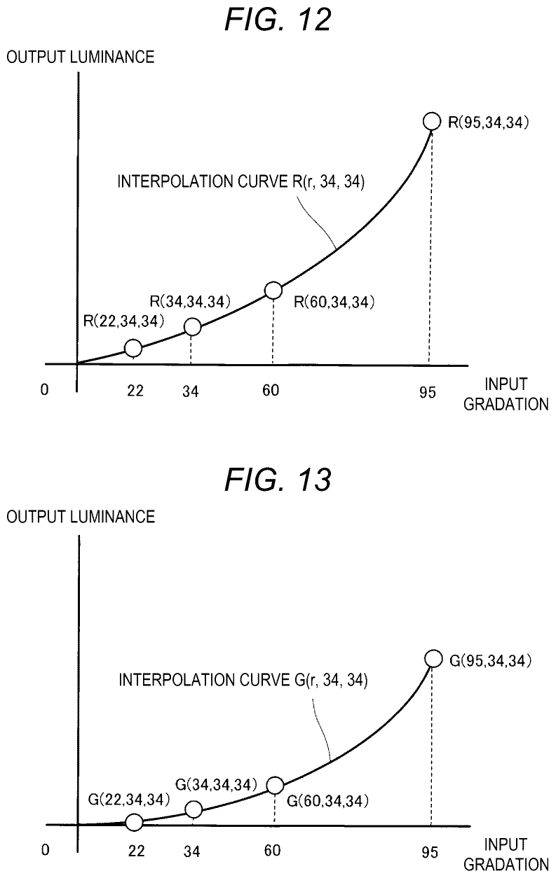

FIG. 12 is a diagram illustrating an example of an interpolation curve R(r, 34, 34) for interpolating the measured value of the R component among the measured values (R, G, B) calculated by the processing device 13 when only r, which is the R component, is changed among the gradation values (r, g, b) of the colored light as the measurement pattern. The interpolation curve R(r, 34, 34) is an example of a “curve indicating a first characteristic”.

FIG. 13 is a diagram illustrating an example of an interpolation curve G(r, 34, 34) for interpolating the measured value of the G component among the measured values (R, G, B) calculated by the processing device 13 when only the r, which is the R component, is changed among the gradation values (r, g, b) of the colored light as the measurement pattern.

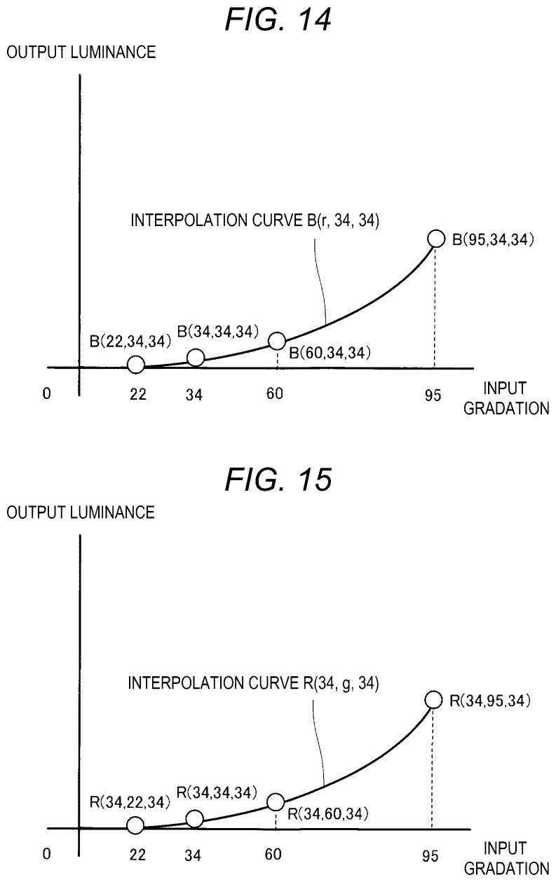

FIG. 14 is a diagram illustrating an example of an interpolation curve B(r, 34, 34) for interpolating the measured value of the B component among the measured values (R, G, B) calculated by the processing device 13 when only the R, which is the R component, is changed among the gradation values (r, g, b) of the colored light as the measurement pattern.

By using the three interpolation curves R(r, 34, 34), G(r, 34, 34), and B(r, 34, 34), the processing device 13 can estimate the measured values (R, G, B)_{(r, g, b)}=(R_{(r, g, b)}, G(r, g, b), B_{(r, g, b)} when the colored light having the R component with any gradation r (0≤r≤95) is projected onto the projection surface SC.

FIG. 15 is a diagram illustrating an example of an interpolation curve R(34, g, 34) for interpolating the measured value of the R component among the measured values (R, G, B) calculated by the processing device 13 when only g, which is the G component, is changed among the gradation values (r, g, b) of the colored light as the measurement pattern.

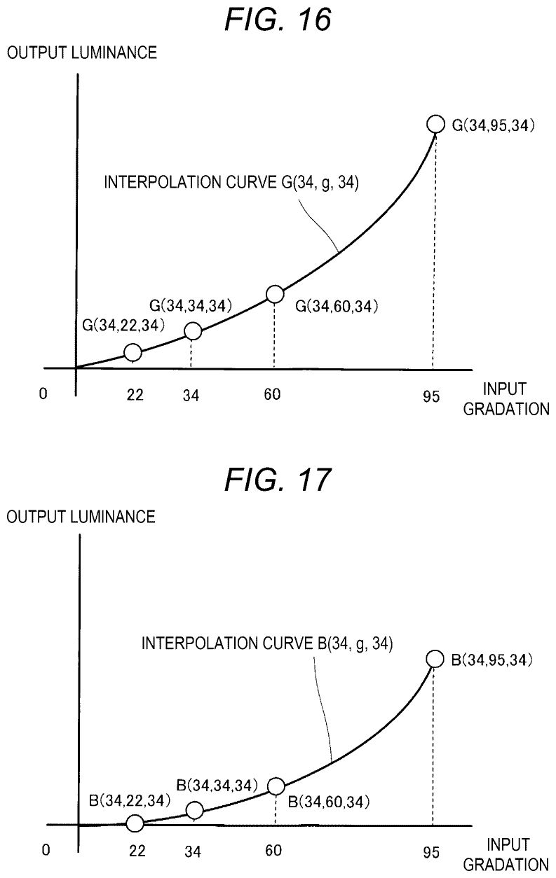

FIG. 16 is a diagram illustrating an example of an interpolation curve G(34, g, 34) for interpolating the measured value of the G component among the measured values (R, G, B) calculated by the processing device 13 when only the g, which is the G component, is changed among the gradation values (r, g, b) of the colored light as the measurement pattern.

FIG. 17 is a diagram illustrating an example of an interpolation curve B(34, g, 34) for interpolating the measured value of the B component among the measured values (R, G, B) calculated by the processing device 13 when only the g, which is the G component, is changed among the gradation values (r, g, b) of the colored light as the measurement pattern.

By using the three interpolation curves R(34, g, 34), G(34, g, 34), and B(34, g, 34), the processing device 13 can estimate the measured values (R, G, B)_{(r, g, b)}=(R(r, g, b), G(r, g, b), B_{(r, g, b)} when the colored light having the G component with any gradation g (0≤g≤95) is projected onto the projection surface SC.

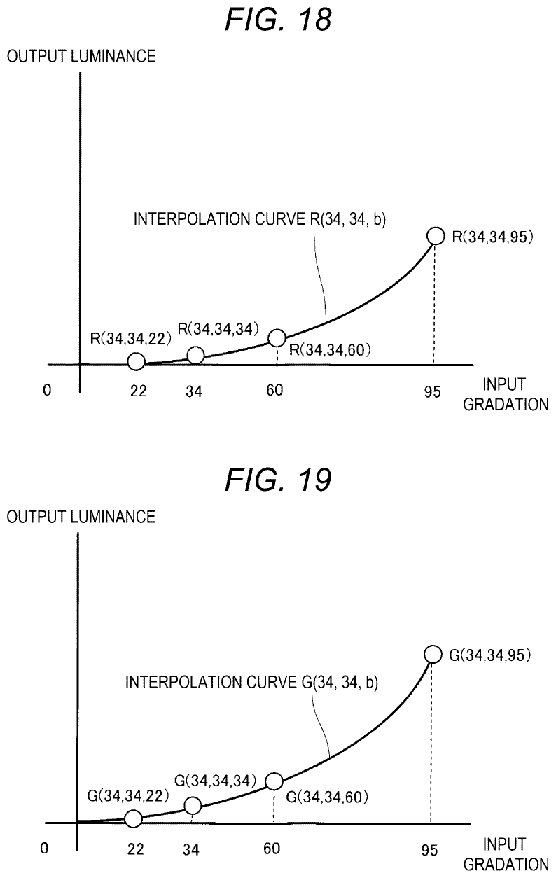

FIG. 18 is a diagram illustrating an example of an interpolation curve R(34, 34, b) for interpolating the measured value of the R component among the measured values (R, G, B) calculated by the processing device 13 when only b, which is the B component, is changed among the gradation values (r, g, b) of the colored light as the measurement pattern.

FIG. 19 is a diagram illustrating an example of an interpolation curve G(34, 34, b) for interpolating the measured value of the G component among the measured values (R, G, B) calculated by the processing device 13 when only the b, which is the B component, is changed among the gradation values (r, g, b) of the colored light as the measurement pattern.

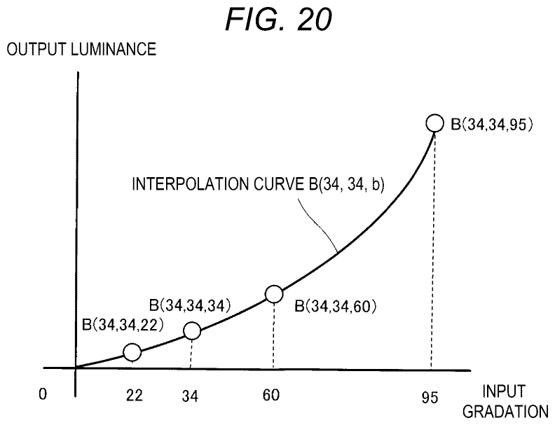

FIG. 20 is a diagram illustrating an example of an interpolation curve B(34, 34, b) for interpolating the measured value of the B component among the measured values (R, G, B) calculated by the processing device 13 when only the b, which is the B component, is changed among the gradation values (r, g, b) of the colored light as the measurement pattern.

By using the three interpolation curves R(34, 34, b), G(34, 34, b), and B(34, 34, b), the processing device 13 can estimate the measured values (R, G, B)_{(r, g, b)}=(R_{(r, g, b)}, G_{(r, g, b)}, B_{(r, g, b)} when the colored light having the B component with any gradation b (0≤b≤95) is projected onto the projection surface SC.

As a result, it is possible to estimate the measured value (R, G, B)_{(r, g, b)}=(R_{(r, g, b)}, G(r, g, b), B_{(r, g, b)} when only one color component of the gradation values (r, g, b) of the colored light projected from the projector 11 is changed and the other color components are fixed to the gradation 34 as illustrated in the following Formulas 6 to 8 using the functions of the interpolation curve R(r, 34, 34), the interpolation curve G(r, 34, 34), the interpolation curve B(r, 34, 34), the interpolation curve R(34, g, 34), the interpolation curve G(34, g, 34), the interpolation curve B(34, g, 34), the interpolation curve R(34, 34, b), the interpolation curve G(34, 34, b), and the interpolation curve B(34, 34, b).

$${( R , G , B )}_{( r , 34 , 34 )} = ( {R}_{( r , 34 , 34 )} , {G}_{( r , 34 , 34 )} , {B}_{( r , 34 , 34 )} ) \qquad [ 6 ]$$

$${( R , G , B )}_{( 34 , g , 34 )} = ( {R}_{( 34 , g , 34 )} , {G}_{( 34 , g , 34 )} , {B}_{( 34 , g , 34 )} ) \qquad [ 7 ]$$

$${( R , G , B )}_{( 34 , 34 , b )} = ( {R}_{( 34 , 34 , b )} , {G}_{( 34 , 34 , b )} , {B}_{( 34 , 34 , b )} ) \qquad [ 8 ]$$

In Formulas 6 to 8 described above, among the gradation values (r, g, b) of the colored light projected from the projector 11, one component of r of the R component, g of the G component, and b of the B component is freely changed, and the other two components are fixed to the gradation 34. Therefore, by applying the property of the additive color mixture to Formulas 6 to 8, the processing device 13 can estimate the measured value (R, G, B)_{(r, g, b)}=(R_{(r, g, b)}, G_{(r, g, b)}, B_{(r, g, b)} when all the components of r of the R component, g of the G component, and b of the B component are freely changed among the gradation values (r, g, b) (0≤r, g, b≤95) of the colored light by using Formula 9 below.

$${( R , G , B )}_{( r , g , b )} = {( R , G , B )}_{( r , 34 , 34 )} + {( R , G , B )}_{( 34 , g , 34 )} + {( R , G , B )}_{( 34 , 34 , b )} - 2 \times {( R , G , B )}_{( 34 , 34 , 34 )} \qquad [ 9 ]$$

In Formula 9, an origin of the additive color mixture is not (r, g, b)=(0, 0, 0) but (r, g, b)=(34, 34, 34). When Formula 9 is expressed for each component, the following Formulas 10 to 12 are obtained.

$${R}_{( r , g , b )} = {R}_{( r , 34 , 34 )} + {R}_{( 34 , g , 34 )} + {R}_{( 34 , 34 , b )} - 2 \times {R}_{( 34 , 34 , 34 )} \qquad [ 10 ]$$

$${G}_{( r , g , b )} = {G}_{( r , 34 , 34 )} + {G}_{( 34 , g , 34 )} + {G}_{( 34 , 34 , b )} - 2 \times {G}_{( 34 , 34 , 34 )} \qquad [ 11 ]$$

$${B}_{( r , g , b )} = {B}_{( r , 34 , 34 )} + {B}_{( 34 , g , 34 )} + {B}_{( 34 , 34 , b )} - 2 \times {B}_{( 34 , 34 , 34 )} \qquad [ 12 ]$$

The image analyzer 133 converts the RGB values into XYZ values by using Formula 13 in which a matrix having components R_{(r, g, b)}, G_{(r, g, b)} and B_{(r, g, b)}, which are the RGB values calculated by Formulas 10 to 12, is multiplied by a transformation matrix M specific to the imaging device 12. As a result, the image analyzer 133 can estimate output values XYZ for any gradation. The transformation matrix M is a matrix for transforming the RGB values and the output values XYZ to each other, and is determined by performing well-known calibration on the imaging device 12 in advance.

$${( \begin{matrix}X \\ Y \\ Z\end{matrix} )}_{( r , g , b )} = ( \begin{matrix}{X}_{( r , g , b )} \\ {Y}_{( r , g , b )} \\ {Z}_{( r , g , b )}\end{matrix} ) = M \times ( \begin{matrix}{R}_{( r , g , b )} \\ {G}_{( r , g , b )} \\ {B}_{( r , g , b )}\end{matrix} ) \qquad [ 13 ]$$

The image analyzer 133 calculates a brightness component Y and a chromaticity component u′v′ by converting the estimated XYZ values into Yu′v′ values using the following Formula 14.

$${u}^{′} = \frac{4 X}{X + 15 Y + 3 Z} , {v}^{′} = \frac{9 Y}{X + 15 Y + 3 Z} \qquad [ 14 ]$$

In step S4, the processing device 13 provided in the projecting apparatus 10A functions as the correction value calculator 134. The processing device 13 calculates the correction values to be set in respective one of the brightness correction circuit LC and the color unevenness correction circuit UC so that the brightness of the black after the correction becomes a target brightness when viewed from the imaging device 12, the black color unevenness after the correction is prevented, and the chromaticity becomes uniform when viewed from the imaging device 12.

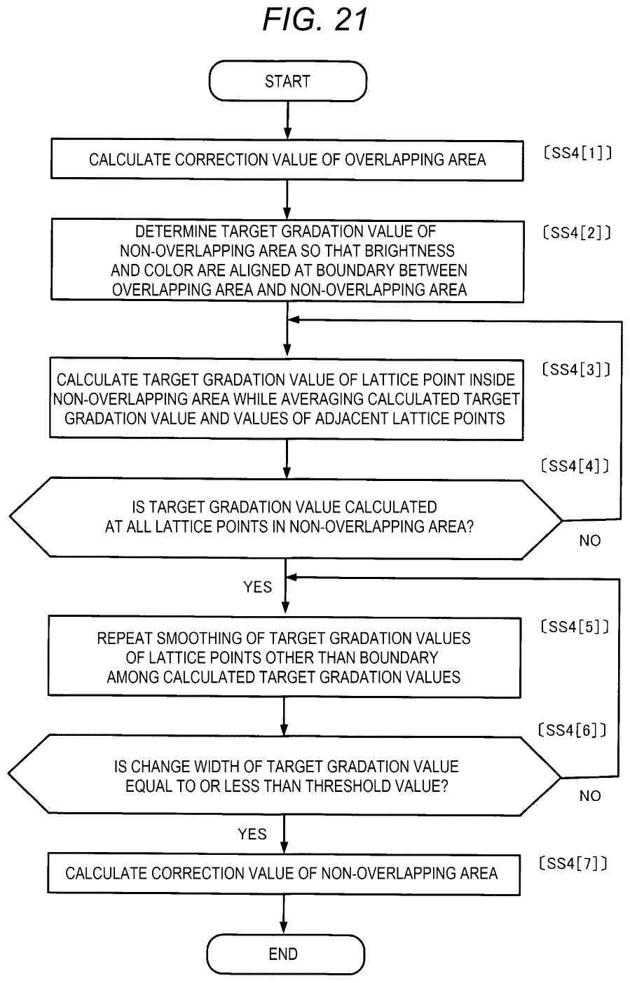

FIG. 21 is a flowchart illustrating sub-steps SS4[1] to SS4[7] constituting step S4. In the flowchart illustrated in FIG. 21, the processing device 13 first calculates the correction values of the overlapping area DR, and then calculates the target values of the brightness and the chromaticity to be the targets of the correction of the non-overlapping area NR. Thereafter, the processing device 13 calculates a correction value in the non-overlapping area NR based on the calculated target value.

In sub-step SS4[1], the processing device 13 functions as the correction value calculator 134. The processing device 13 calculates the correction value at the lattice point DP provided in the overlapping area DR on the assumption that the target brightness and chromaticity in the overlapping area DR are already determined by a known method. The processing device 13 may use a known method as the calculation method for the correction value.

As an example, in FIG. 1, the target value of the brightness of the R component in the area RL1 of the overlapping area DR is an example of a “first target value”. The target value of the brightness of the R component in the area RL4 of the overlapping area DR is an example of a “second target value”. The target value of the brightness of the G component in the area RL1 of the overlapping area DR is an example of a “third target value”. The target value of the brightness of the G component in the area RL4 of the overlapping area DR is an example of a “fourth target value”. The target value of the brightness of the B component in the area RL1 of the overlapping area DR is an example of a “fifth target value”. The target value of the brightness of the B component in the area RL4 of the overlapping area DR is an example of a “sixth target value”. In the present embodiment, the first target value to the sixth target value are different values for each of the plurality of lattice points LP. Each of the first target value to the sixth target value may be one value.

As a result of the correction to be described later, the brightness in the overlapping area DR is maintained at the brightness corresponding to these target values.

The processing device 13 calculates a correction value of a parameter that defines the brightness of the area RL3 provided in the non-overlapping area NR based on these target values.

Specifically, the processing device 13 determines a target gradation value of the brightness of the overlapping area DR in advance. The gradation value is a gradation value at which the output luminance is expected to be an output gradation corresponding to the output luminance expected after the color unevenness correction in FIG. 3. The processing device 13 calculates the brightness component Y as a target value from the determined gradation value for each lattice point DP of the overlapping area DR illustrated in FIGS. 9 to 11. The “brightness component Y as a target value” is the brightness component Y as the target value for correcting the “black floating” described above.

The processing device 13 calculates the brightness component Y as the target value for each lattice point DP. Specifically, even if luminance unevenness originally exists in the overlapping area DR, the processing device 13 does not adjust the luminance unevenness uniformly in the overlapping area DR, but calculates an amount of correction corresponding to the brightness component Y as the target value for each lattice point DP. When the processing device 13 uniformly adjusts the luminance unevenness, it is necessary to reduce the luminance at each lattice point DP, and in this case, the number of steps of the gradation that can be corrected at each lattice point DP is reduced. The reason why the processing device 13 determines the brightness component Y as the target value for each lattice point DP in advance is to ensure the minimum amount of correction that can remove color unevenness as described above uniformly at all lattice points DP.

The processing device 13 determines the chromaticity component u′v′ as a target value of the chromaticity of the overlapping area DR in advance. The “chromaticity component u′v′ as a target value” is a chromaticity component u′v′ as a target value for correcting the color unevenness described above. The processing device 13 determines the chromaticity component u′v′ as the same target value in all the overlapping areas DR based on an average chromaticity among the three projecting apparatuses 10 of the projecting apparatus 10A, the projecting apparatus 10B, and the projecting apparatus 10C, an average chromaticity in each projecting apparatus 10, and a chromaticity design value at the time of product shipment of each projecting apparatus 10. In this case, after the correction, all the overlapping areas DR have the same chromaticity.

Alternatively, the processing device 13 determines the chromaticity component u′v′ as the same target value in the overlapping areas DR based on the parameters described above. In this case, after the correction, the chromaticity is the same in each overlapping area DR.

As a result, the color unevenness in the overlapping area DR is corrected.

The processing device 13 converts the Yu′v′ value as the target value including the brightness component Y as the target value and the chromaticity component u′v′ as the target value at each lattice point DP in the overlapping area DR into the RGB values by using Formulas 13 and 14 described above. Further, the processing device 13 calculates back the converted RGB values to the target gradation values (r, g, b) output from the corrector 136 to the projection controller 131. The processing device 13 sets this as an ideal output value from the corrector 136 to the projector 11.

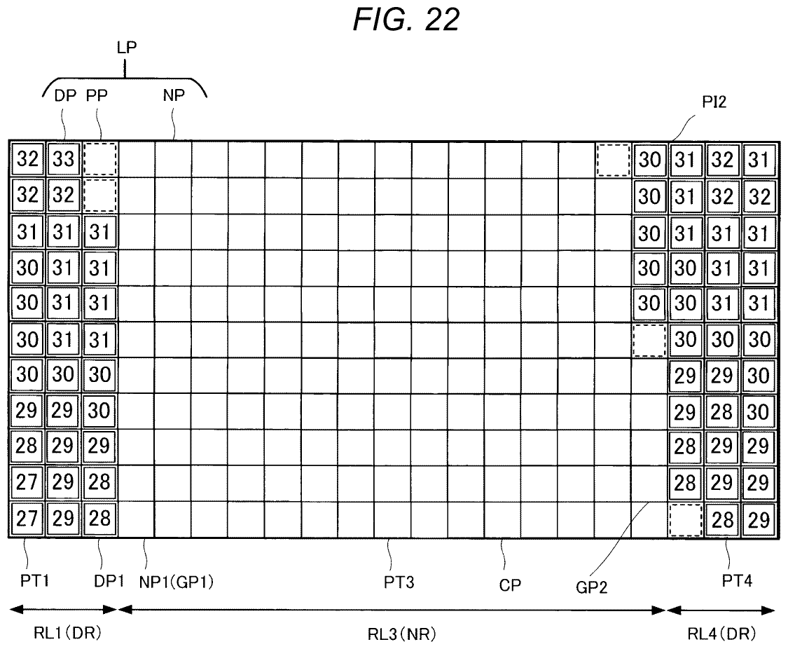

FIG. 22 is a diagram illustrating an example of the target gradation values (r, g, b) at the lattice point DP calculated by the processing device 13. FIG. 22 illustrates an example of a value of one component among the r component, the g component, and the b component included in the gradation values (r, g, b). FIG. 22 corresponds to the projection image PI2 illustrated in FIG. 10.

Further, each rectangle illustrated in FIG. 22 illustrates a portion PT of the projection image PI including each lattice point LP illustrated in FIG. 10. The portion PT1 provided in the area RL1 is an example of a “first portion”. The area RL1 includes a plurality of portions PT1. The portion PT3 provided in the area RL3 is an example of a “third portion”. The area RL3 includes a plurality of portions PT3. The portion PT4 provided in the area RL4 is an example of a “second portion”. The area RL4 includes a plurality of portions PT4.

A numerical value described inside the rectangle is a value of one of the r component, the g component, and the b component included in the target gradation values (r, g, b).

In order to simplify the description, each numerical value is indicated by an integer in FIG. 22, but may be actually a decimal. The same applies to the numerical values illustrated below.

Among the rectangles illustrated in FIG. 22, a rectangle whose frame line is a double line corresponds to the lattice point DP. As described above, the lattice point DP is the lattice point LP provided in the overlapping area DR. A rectangle whose frame line is a single line corresponds to the lattice point NP. As described above, the lattice point NP is the lattice point LP provided in the non-overlapping area NR. A rectangle in which the frame line is double and one line is a dotted line corresponds to the lattice point PP. As described above, the lattice point PP is the lattice point LP for which it is not possible to determine whether it belongs to the overlapping area DR or the non-overlapping area NR.

In sub-step SS4[2] of FIG. 21, the processing device 13 functions as the correction value calculator 134. The processing device 13 determines the target gradation values (r, g, b) at the lattice point NP so that at least brightness is aligned between the lattice point DP belonging to the overlapping area DR and the lattice point NP belonging to the non-overlapping area NR adjacent to each other across a boundary between the overlapping area DR and the non-overlapping area NR. The target gradation values (r, g, b) at the lattice point NP may be determined such that at least the colors are aligned.

The target gradation values (r, g, b) at the lattice point NP are calculated based on the target gradation value (r, g, b) at the lattice point DP. Hereinafter, a specific calculation method will be described.

In FIG. 22, a lattice point DP1 is an example of the lattice point DP. A lattice point NP1 is an example of the lattice point NP. The lattice point DP1 and the lattice point NP1 are adjacent to each other with the boundary between the overlapping area DR and the non-overlapping area NR interposed therebetween.

In FIG. 22, the target gradation value (r, g, b) of the lattice point DP1 has already been calculated. The processing device 13 estimates the RGB values as the measured value by the imaging device 12 by applying Formulas 6 to 8 described above to the gradation values (r, g, b). Further, the processing device 13 converts the RGB values as the measured values into the XYZ values by applying the above Formula 13 to the estimated measured values (R, G, B) (r, g, b). Further, the processing device 13 further converts the converted XYZ values into Yu′v′ values by applying the above Formula 14 to the converted XYZ values.

Accordingly, since the Yu′v′ value of the lattice point DP1 is calculated, the processing device 13 sets the Yu′v′ value as the Yu′v′ value as the target value of the lattice point NP1. Further, the processing device 13 calculates the target gradation values (r, g, b) of the lattice point NP1 by performing back calculation on the Yu′v′ value as the target value using Formulas 6 to 14 described above.

In FIG. 22, the portion PT3 adjacent to the area RL1, such as the portion PT3 including the lattice point NP1, is an example of a “first adjacent portion GP1”. Meanwhile, the portion PT3 adjacent to the area RL4 is an example of a “second adjacent portion GP2”. A target value of the brightness of the R component at the lattice point NP provided in the first adjacent portion GP1 is an example of a “seventh target value”. A target value of the brightness of the R component at the lattice point NP provided in the second adjacent portion GP2 is an example of an “eighth target value”. The area RL3 includes a plurality of intermediate portions CP between the first adjacent portion GP1 and the second adjacent portion GP2. A target value of the brightness of the R component at the lattice point NP provided in the intermediate portion CP is an example of a “ninth target value”.

A direction from the area RL1 toward the area RL4 in FIG. 22 is an example of a “first direction”.

In the following, in order to simplify the description, the target value of brightness among the target values of the lattice point NP1 will be described. Since the calculation method for the target value of chromaticity is the same as the calculation method for the target value of brightness, the description of the target value of brightness is also applied to the target value of chromaticity.

When the brightness of the lattice point NP1 is set as the target value, the processing device 13 calculates the gradation value t such that the r component, the g component, and the b component are (r, g, b)=(t, t, t) as the target gradation values (r, g, b) of the lattice point NP. Specifically, the processing device 13 calculates the gradation value t such that the lattice point DP1 and the lattice point NP1 have the same brightness when the projector 11 projects gray colored light.

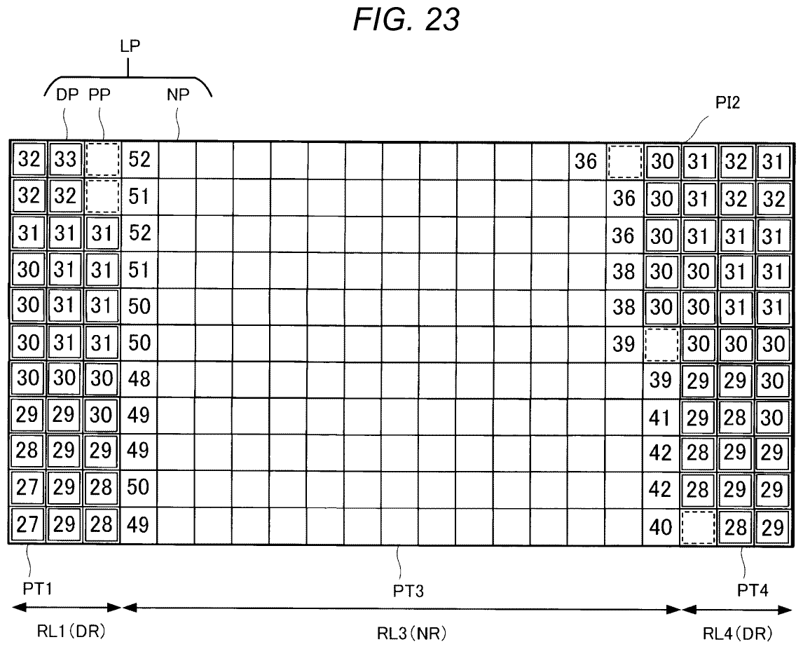

FIG. 23 is a diagram illustrating an example of the target gradation values (r, g, b) at the lattice point DP and the target gradation values t at the lattice points NP adjacent to the boundary between the overlapping area DR and the non-overlapping area NR.

In FIG. 23, the target gradation value t at the lattice point NP is larger than the target gradation value (r, g, b) at the lattice point DP. This is because the brightness of the lattice point DP is substantially twice as high as the brightness of the lattice point NP, and thus it is necessary to increase the target gradation value t of the lattice point NP in the non-overlapping area NR in order to substantially equalize the brightness of the lattice point DP and the brightness of the lattice point NP.

When the correction is not performed, since the non-overlapping area NR is darker than the overlapping area DR, in order to make the brightness component Y the same in the overlapping area DR and the non-overlapping area NR after the correction, it is necessary to make the target gradation value t at the lattice point NP larger than the target gradation values (r, g, b) at the lattice point DP.

In sub-step SS4[3] of FIG. 21, the processing device 13 calculates a further target gradation value t of the lattice point NP by averaging the target gradation value t of the lattice point NP calculated in sub-step SS4[2] and the target gradation value t of the adjacent lattice point NP.

Specifically, for the lattice points NP for which the target gradation value t is not determined, when there are one or more lattice points NP for which the target gradation value t is determined among the lattice points NP adjacent in vertical and horizontal directions, the processing device 13 calculates the average value of the target gradation values t of these lattice points NP. The processing device 13 sets the calculated average value as the target gradation value t of the lattice point NP for which the target gradation value t is not determined.

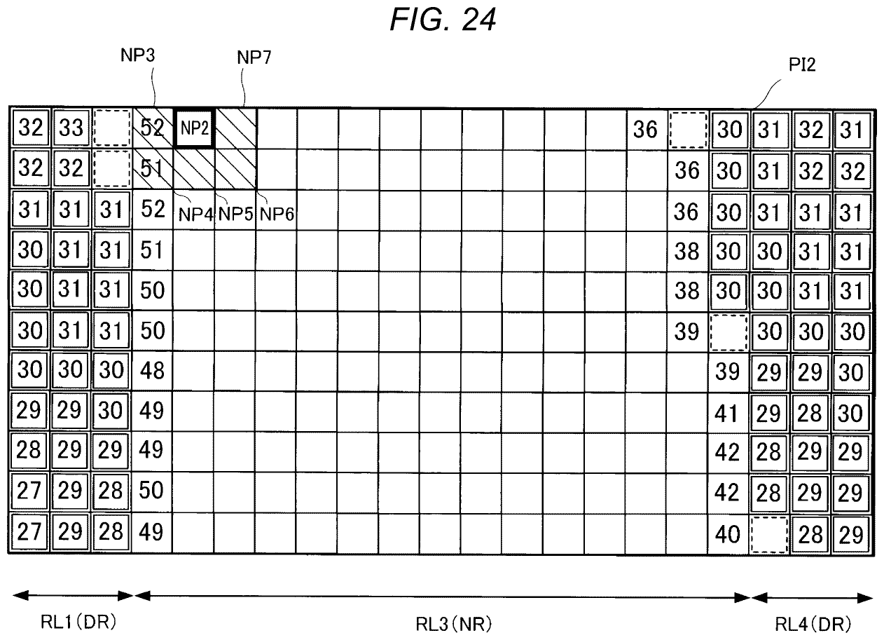

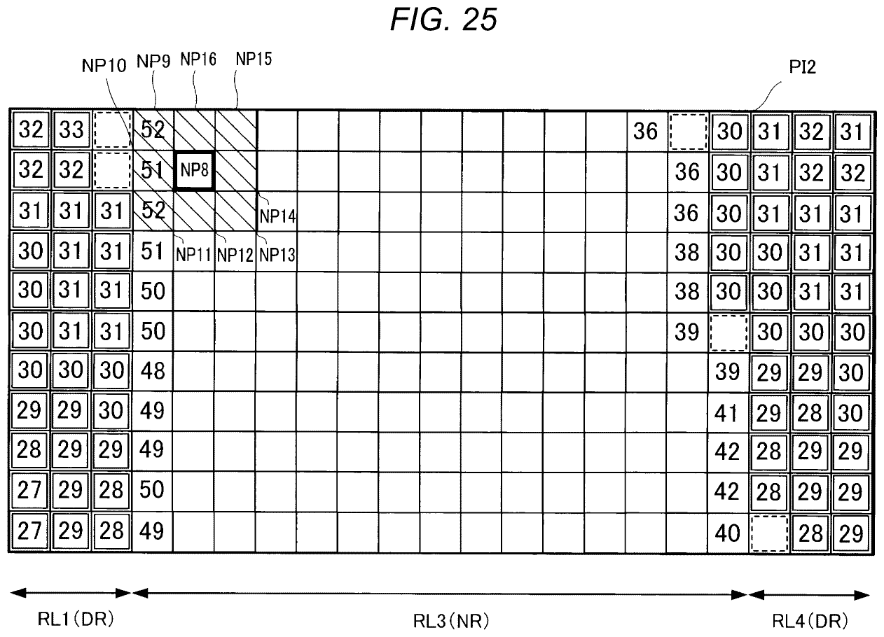

FIGS. 24 and 25 are diagrams illustrating an example of a method for determining the target gradation value t of the lattice point NP for which the target gradation value t is not determined.

In FIG. 24, a lattice point NP2 for which the target gradation value t is not determined is located at an end of the non-overlapping area NR. In this case, as the lattice points NP adjacent to the lattice point NP2, there are five lattice points NP from a lattice point NP3 to a lattice point NP7. A target gradation value t=52 is set at the lattice point NP3 among the lattice point NP3 to the lattice point NP7. A target gradation value t=51 is set at the lattice point NP4. On the other hand, the target gradation value t is not set for each of the lattice point NP5 to the lattice point NP7. Therefore, the processing device 13 sets the average value of the target gradation value t=52 of the lattice point NP3 and the target gradation value t=51 of the lattice point NP4 as the target gradation value t of the lattice point NP2.

In FIG. 25, a lattice point NP8 for which the target gradation value t is not determined is located inside the non-overlapping area NR. In this case, there are eight lattice points NP from a lattice point NP9 to a lattice point NP16 as the lattice points NP adjacent to the lattice point NP8. Among these eight lattice points NP, a target gradation value t=52 is set at the lattice point NP9. A target gradation value t=51 is set at the lattice point NP10. A target gradation value t=52 is set at the lattice point NP11. On the other hand, the target gradation value t is not set for each of the lattice point NP12 to the lattice point NP16. Therefore, the processing device 13 sets the average value of the target gradation value t=52 of the lattice point NP9, the target gradation value t=51 of the lattice point NP10, and the target gradation value t=52 of the lattice point NP11 as the target gradation value t of the lattice point NP8.

In sub-step SS4[4] of FIG. 21, the processing device 13 functions as the correction value calculator 134. The processing device 13 determines whether the target gradation value t is calculated for all the lattice points NP in the non-overlapping area NR. When the target gradation value t is calculated for all the lattice points NP in the non-overlapping area NR (“YES” in sub-step SS4[4]), the processing device 13 executes a process of sub-step SS4[5]. On the other hand, when the target gradation value t is not calculated for all the lattice points NP in the non-overlapping area NR (“NO” in sub-step SS4[4]), the processing device 13 executes the process of sub-step SS4[3].

As a result, the processing device 13 sequentially extends the lattice point NP for calculating the target gradation value t to the inside of the non-overlapping area NR.

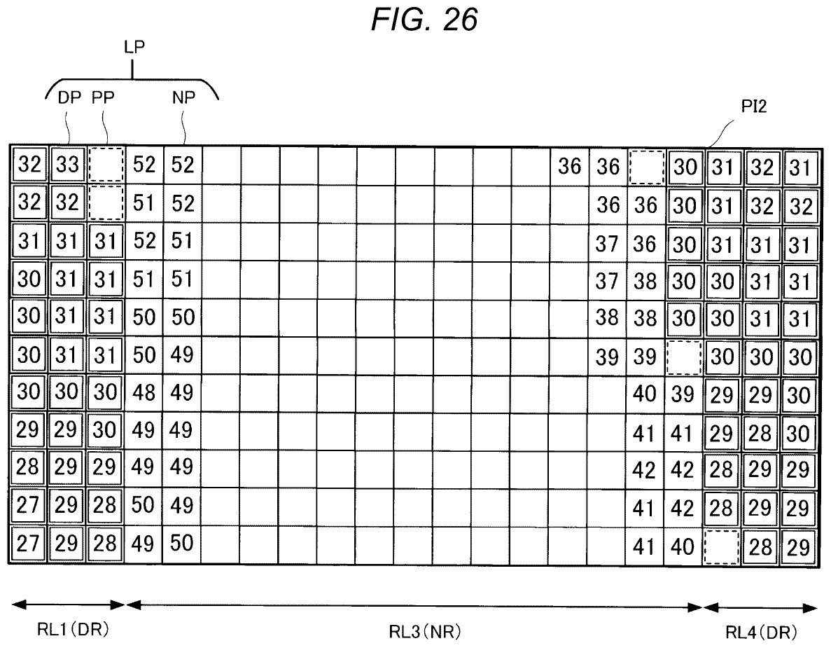

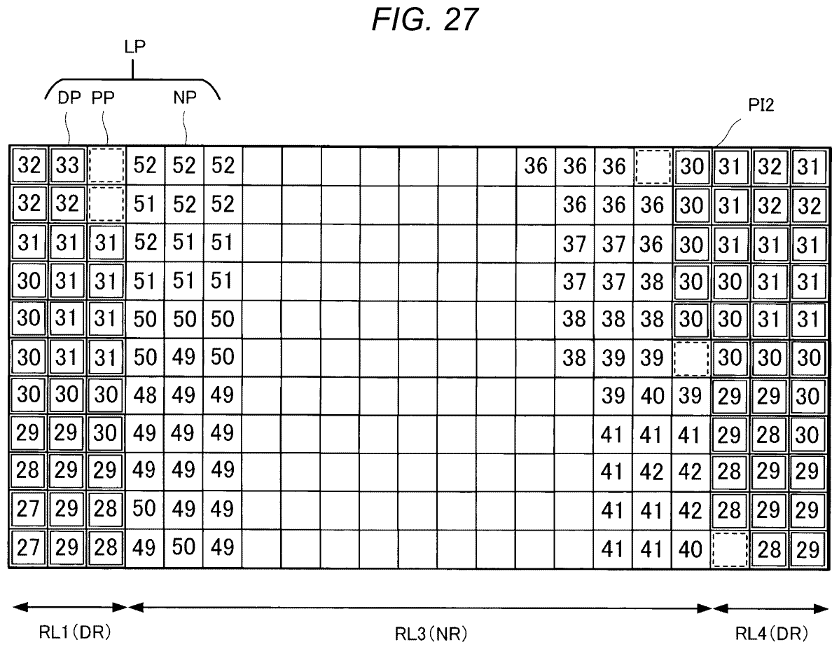

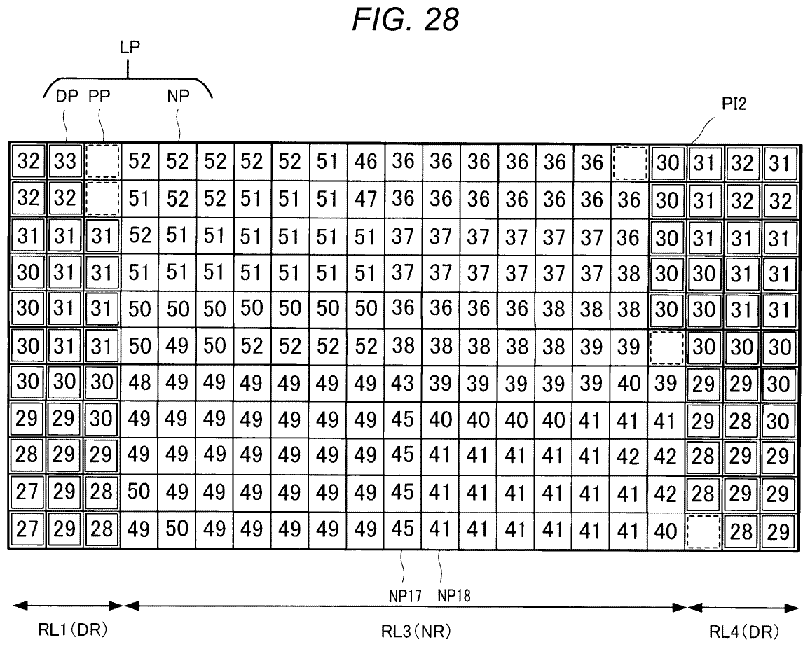

FIGS. 26 to 28 are diagrams illustrating examples of calculation situations of the target gradation value t. More specifically, FIG. 26 is a diagram illustrating the calculation situation of the target gradation values t of the lattice points NP adjacent to the inner side of the non-overlapping area NR with respect to the lattice points NP adjacent to the boundary between the overlapping area DR and the non-overlapping area NR as compared with the state of FIG. 25. FIG. 27 is a diagram illustrating a calculation situation of the target gradation values t of the lattice points NP adjacent to the inside of the non-overlapping area NR with respect to the lattice points NP for which the target gradation values t are newly calculated in FIG. 26. FIG. 28 is a diagram illustrating a situation in which the target gradation values t of all the lattice points NP are calculated.

In sub-step SS4[5] of FIG. 21, the processing device 13 functions as the correction value calculator 134. The processing device 13 repeats smoothing of the target gradation values t of the lattice points NP other than the lattice points NP adjacent to the boundary between the overlapping area DR and the non-overlapping area NR among the calculated target gradation values t. Specifically, the processing device 13 smooths the lattice points NP other than the lattice points NP adjacent to the boundary using the target gradation value t of an effective lattice point NP among the lattice points NP adjacent in the vertical and horizontal directions.

As illustrated in FIG. 28, when calculating the target gradation value t of the lattice point NP, the processing device 13 sequentially calculates the target gradation value t of the lattice point NP adjacent to the inner side of the non-overlapping area NR, that is, the right side from the area RL1 which is the first overlapping area DR as described above. In parallel with this, the processing device 13 sequentially calculates the target gradation value t of the lattice point NP adjacent to the inside of the non-overlapping area NR, that is, the left side, from the area RL4 which is the second overlapping area DR. Therefore, in FIG. 28, as an example, a large difference occurs between the target gradation value t=45 of the lattice point NP17 and the target gradation value t=41 of the lattice point NP18 adjacent to the lattice point NP17. In other words, a step is generated between the target gradation value t=45 of the lattice point NP17 and the target gradation value t=41 of the lattice point NP18.

The processing device 13 performs the above smoothing so as to eliminate steps in the interpolated target gradation value t and to smoothly link the target gradation values t of the lattice points NP provided in the non-overlapping area NR from the area RL1, which is the first overlapping area DR, toward the area RL4, which is the second overlapping area DR.

As a result, as described later, the target gradation value t which is a parameter defining the brightness of the area RL3, which is the non-overlapping area NR, has a continuous or stepwise distribution in the direction from the area RL1 to the area RL4.

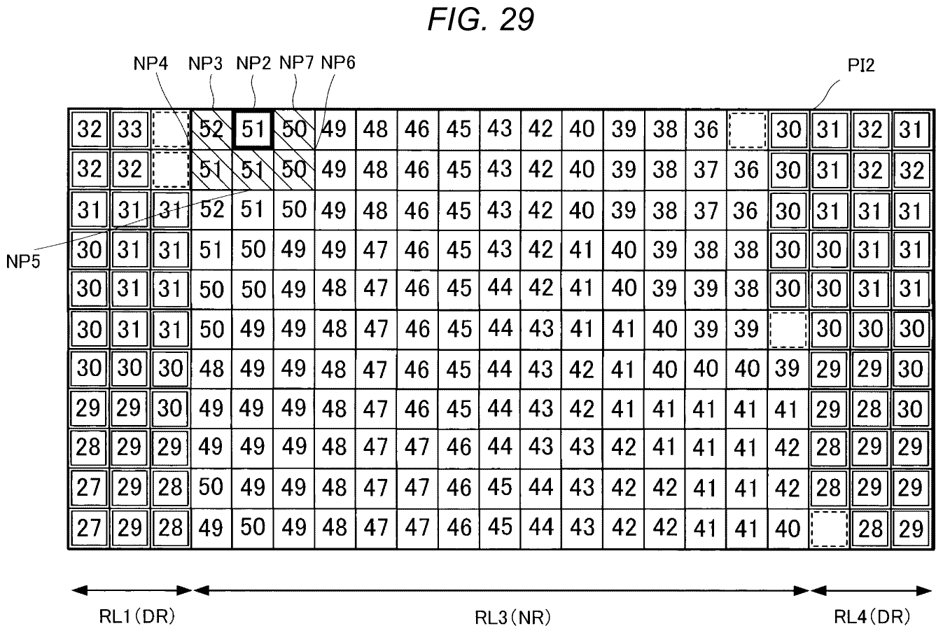

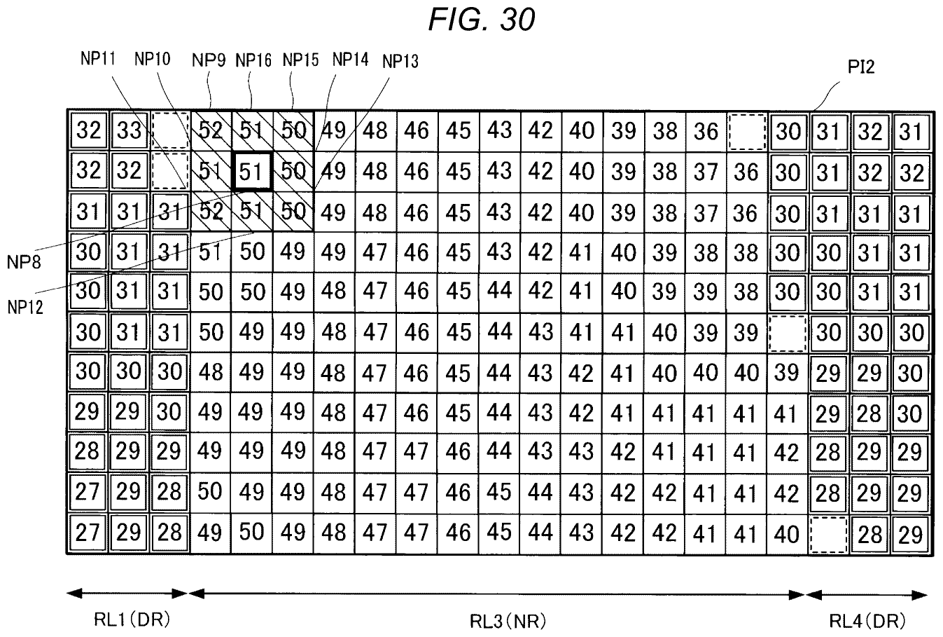

FIGS. 29 and 30 are diagrams illustrating examples of smoothing. FIG. 29 corresponds to FIG. 24. FIG. 30 corresponds to FIG. 25.

In FIG. 29, the processing device 13 smoothes the target gradation value t=51 of the lattice point NP2 using the target gradation value t=52 of the lattice point NP3, the target gradation value t=51 of the lattice point NP4, the target gradation value t=51 of the lattice point NP5, the target gradation value t=50 of the lattice point NP6, and the target gradation value t=50 of the lattice point NP7.

In FIG. 30, the processing device 13 smoothes the target gradation value t=51 of the lattice point NP8 using the target gradation value t=52 of the lattice point NP9, the target gradation value t=51 of the lattice point NP10, the target gradation value t=52 of the lattice point NP11, the target gradation value t=51 of the lattice point NP12, the target gradation value t=50 of the lattice point NP13, the target gradation value t=50 of the lattice point NP14, the target gradation value t=50 of the lattice point NP15, and the target gradation value t=51 of the lattice point NP16.

In sub-step SS4[6] of FIG. 21, the processing device 13 functions as the correction value calculator 134. The processing device 13 determines whether a change width of the target gradation value t of the lattice point NP is equal to or less than a threshold value before and after the smoothing. More specifically, the processing device 13 determines whether the sum of the change widths of the target gradation values t of all the lattice points NP is equal to or less than a threshold value. When the sum of the change widths of the target gradation values t of all the lattice points NP is equal to or less than the threshold value (“YES” in sub-step SS4[6]), the processing device 13 executes a process of sub-step SS4[7]. On the other hand, when the sum of the change widths of the target gradation values t of all the lattice points NP exceeds the threshold value (“NO” in sub-step SS4[6]), the processing device 13 executes the process of sub-step SS4[5].

That is, the processing device 13 repeats smoothing until the sum of the change widths of the target gradation values t of all the lattice points NP becomes equal to or less than the threshold value.

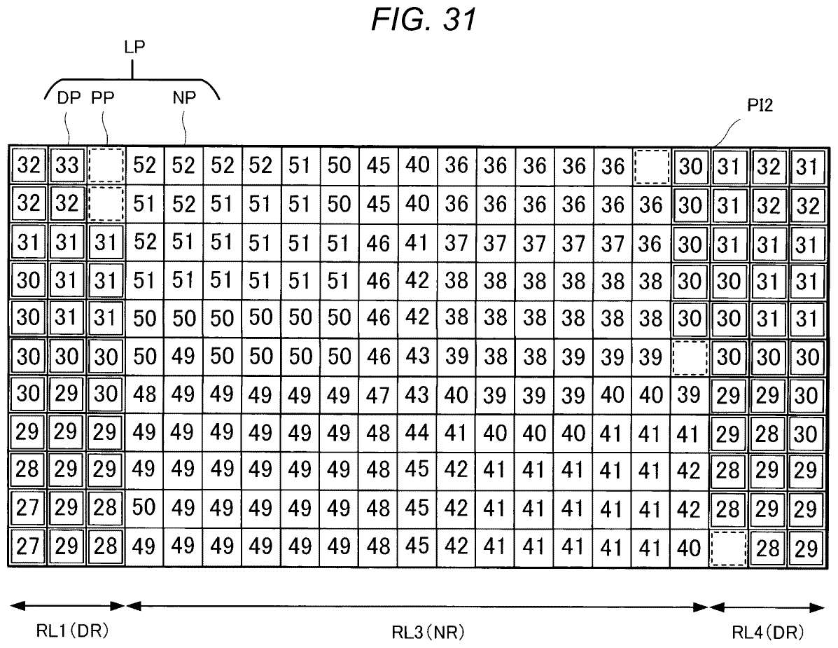

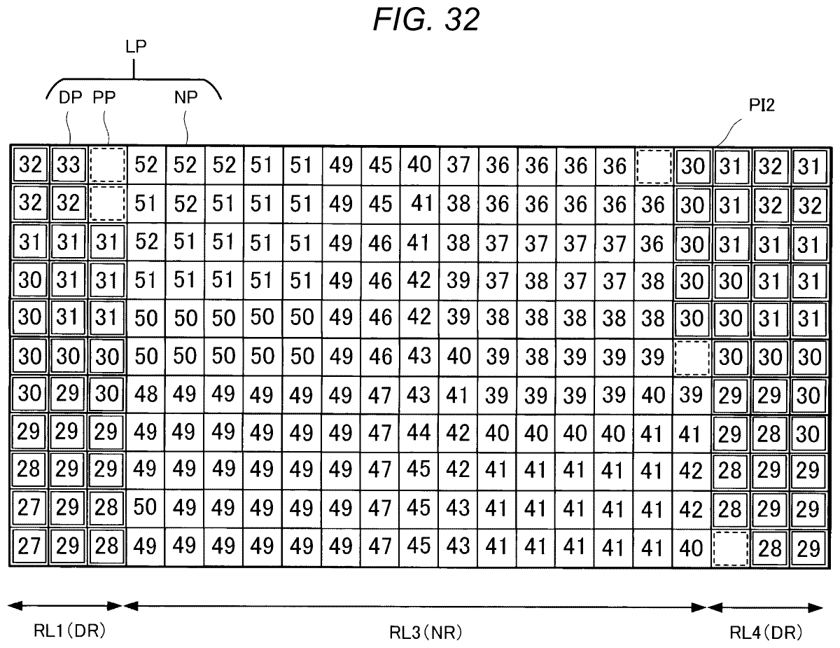

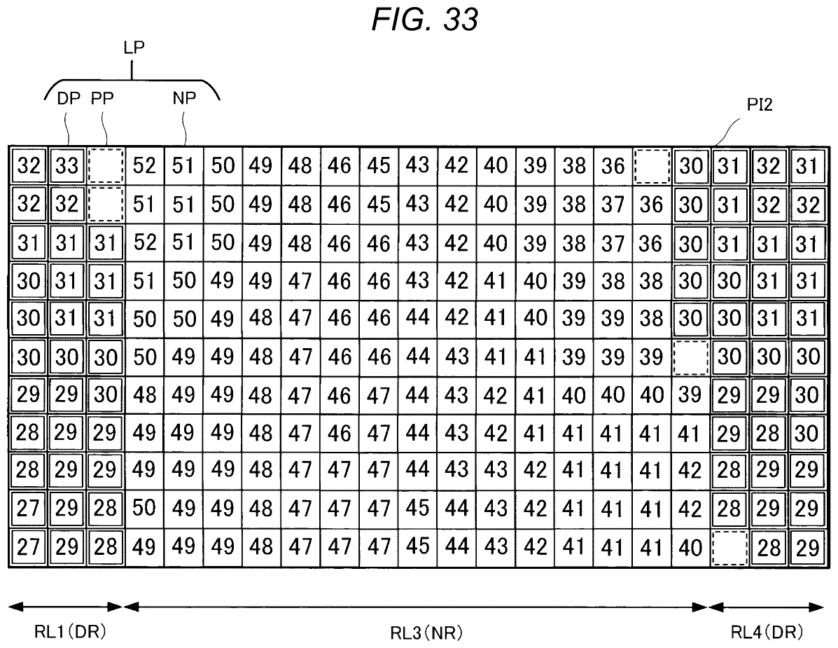

FIGS. 31 to 33 are diagrams illustrating examples of a situation of smoothing of the target gradation value t. More specifically, FIG. 31 is a diagram illustrating an example of the target gradation value t after a first smoothing process. FIG. 32 is a diagram illustrating an example of the target gradation value t after a second smoothing process. FIG. 33 is a diagram illustrating an example of the target gradation value t after an eighteenth smoothing process. It is assumed that the smoothing is completed through the eighteenth smoothing process illustrated in FIG. 33.

As is clear from comparison between FIGS. 31 to 33, as the number of smoothing processes increases, the difference in the target gradation value t between the lattice points NP adjacent to each other decreases as a whole.

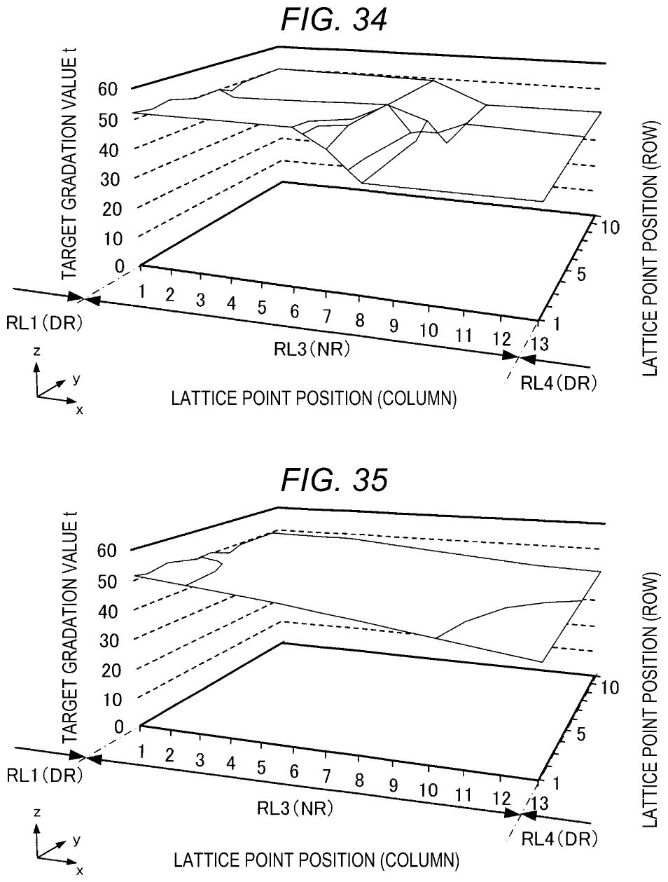

FIG. 34 is a diagram illustrating a stereoscopic display of the target gradation value t of each lattice point NP before smoothing. FIG. 35 is a diagram illustrating a stereoscopic display of the target gradation value t of each lattice point NP after the smoothing is completed. In both FIGS. 34 and 35, an x axis indicates a position of the lattice point NP in a column direction. A y axis indicates a position of the lattice point NP in a row direction. A z axis indicates the target gradation value t.

As is clear from a comparison between FIGS. 34 and 35, after the smoothing is completed, the step of the target gradation value t is eliminated as compared with before the smoothing.

In sub-step SS4[7] of FIG. 21, the processing device 13 functions as the correction value calculator 134. The processing device 13 calculates a correction value at the lattice point NP provided in the non-overlapping area NR.

As described above, the processing device 13 determines the target gradation values (t, t, t) of the brightness at the lattice point NP after the smoothing is completed by the process up to sub-step SS4[6]. The processing device 13 calculates a correction value at the lattice point NP based on the target gradation values (t, t, t). The processing device 13 may use a known method as the calculation method for the correction value.

Specifically, the processing device 13 calculates the brightness component from the target gradation values (t, t, t). The processing device 13 sets the calculated brightness component as the brightness component Y of the target value.

As described above, the processing device 13 determines the chromaticity component u′v′ of the target value in the same manner as the brightness component Y of the target value at the lattice point NP.

The processing device 13 converts the Yu′v′ value as the target value at each lattice point NP in the non-overlapping area NR into the RGB value by using Formulas 13 and 14. Further, the processing device 13 calculates back the converted RGB values to the target gradation values (r, g, b) as the correction values output from the corrector 136 to the projector 11.

In step S5 in FIG. 8, the processing device 13 provided in the projecting apparatus 10A functions as the correction value calculator 134. The processing device 13 sets the correction values calculated in step S4 in the brightness correction circuit LC and the color unevenness correction circuit UC.

In FIG. 2, the image acquired by the processing device 13 functioning as the image acquisition unit 135 is corrected by the brightness correction circuit LC and the color unevenness correction circuit UC in which the correction values are set. As a result, the projection image PI in which the black color unevenness and the “black floating” are corrected is projected from the projector 11 onto the projection surface SC.

### 2: Modifications

The embodiment described above can be modified in various manners. Specific aspects of the modifications will be presented below by way of example. The aspects presented below by way of example and the aspects shown in the embodiment described above can be combined with each other as appropriate to the extent that the aspects to be combined with each other do not contradict each other. Note that, in the modifications exemplified below, elements having effects and functions equivalent to those in the embodiment are denoted by the reference numerals and signs referred to in the above explanation and detailed explanation of the elements is omitted as appropriate.

### 2-1: Modification 1

In the embodiment described above, as an example, the processing device 13 determines the gradation value t as the target value at the lattice point NP provided in the non-overlapping area NR. However, the processing device 13 may determine the target values of the brightness and the chromaticity of the lattice point DP provided in the overlapping area DR and the lattice point NP provided in the non-overlapping area NR by another method.

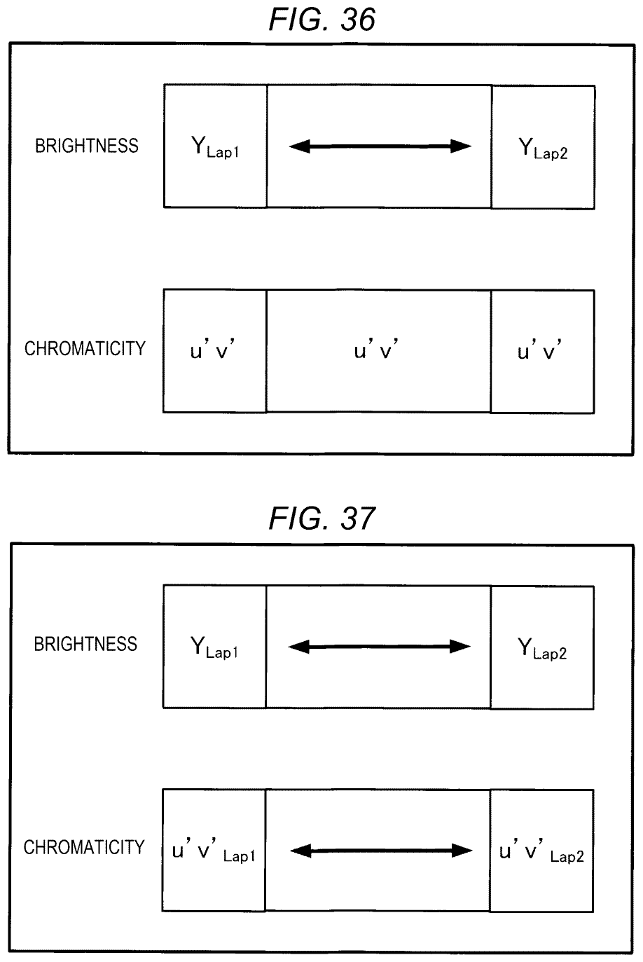

FIGS. 36 to 38 are diagrams s illustrating a method for determining the target values of the brightness and the chromaticity at each of the lattice point DP and the lattice point NP according to Modification 1.

As illustrated in FIG. 36, regarding the target value of the brightness of the lattice point NP, the processing device 13 smoothly links the target values of the lattice points NP provided in the non-overlapping area NR from a target value Y_{Lap1} of the lattice point DP in the area RL1, which is the first overlapping area DR, toward a target value Y_{Lap2} of the lattice point DP in the area RL4, which is the second overlapping area DR. On the other hand, regarding the target value of the chromaticity of the lattice point NP, the processing device 13 may set the chromaticity component u′v′ of the uniform target value in the area RL1, which is the first overlapping area DR, the area RL4, which is the second overlapping area DR, and the non-overlapping area NR.

Alternatively, as illustrated in FIG. 37, regarding the target value of the brightness of the lattice point NP, the processing device 13 smoothly links the target values of the lattice points NP provided in the non-overlapping area NR from the target value Y_{Lap1} of the lattice point DP in the area RL1, which is the first overlapping area DR, toward the target value Y_{Lap2} of the lattice point DP in the area RL4, which is the second overlapping area DR. Further, regarding the target values of the chromaticity of the lattice points NP, the processing device 13 may smoothly link the target values of the lattice points NP provided in the non-overlapping area NR from a target value u′v′_{Lap1} Of the lattice point DP in the area RL1, which is the first overlapping area DR, toward a target value u′v′_{Lap2} of the lattice point DP in the area RL4, which is the second overlapping area DR.

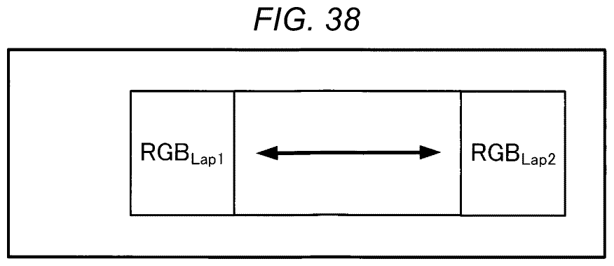

Alternatively, as illustrated in FIG. 38, the processing device 13 may determine the target value of the lattice point NP provided in the non-overlapping area NR using the RGB values instead of the Yu′v′ values by the same method as illustrated in FIG. 37.

When the processing device 13 uses the method of FIG. 38, as an example, in FIG. 22, the brightness of the R component in the area RL1 is an average value of the brightness of the R component in the plurality of portions PT1 provided in the area RL1. The brightness of the R component in the area RL3 is the brightness of the R component in the plurality of portions PT3 provided in the area RL3. The brightness of the R component in the area RL4 is an average value of the brightness of the R component in the plurality of portions PT4 provided in the area RL1.

### 2-2: Modification 2

In the embodiment described above, the processing device 13 performs the smoothing described above such that the gradation values (t, t, t) as the target values of the lattice points NP provided in the non-overlapping area NR are smoothly linked from the area RL1, which is the first overlapping area DR, toward the area RL4, which is the second overlapping area DR.

However, the processing device 13 may perform the smoothing described above such that the brightness components Y of the target values of the lattice points NP provided in the non-overlapping area NR are smoothly linked from the area RL1, which is the first overlapping area DR, toward the area RL4, which is the second overlapping area DR.

The brightness component Y is an example of the “parameter”.

### 3: Summary of Present Disclosure

A summary of the present disclosure is appended below.

(Appendix 1) A correction method fora projection image projected from a projecting apparatus, the correction method including: acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data; and calculating correction data for correcting a color of an image displayed on the projection surface based on the plurality of pieces of gradation data and the plurality of pieces of measurement data, in which the projection image has a first area overlapping the first projection image, a second area overlapping the second projection image, and a third area not overlapping the first projection image and the second projection image in a state in which the projection image is projected onto the projection surface, the plurality of pieces of gradation data include at least one gradation value indicating at least one gradation of a first color component, the plurality of pieces of measurement data include a brightness value indicating brightness of reflected light of colored light corresponding to the first color component having the at least one gradation value, and the calculating the correction data includes determining a first target value that is a target of brightness of the first color component in the first area and a second target value that is a target of brightness of the first color component in the second area based on the plurality of pieces of gradation data and the plurality of pieces of measurement data, and calculating a correction value of a parameter that defines brightness of the third area, based on the first target value and the second target value, so that a distribution of the parameter is a continuous or stepwise distribution in a first direction from the first area toward the second area.

With the configuration described above, the correction method of Appendix 1 can correct black color unevenness and the brightness in the projection image PI when a tiled display is performed using the plurality of projecting apparatuses 10 without deteriorating a contrast ratio in the entire projection image PI.

Specifically, even if the brightness of the R component of the area RL1, which is the first overlapping area DR, at the maximum gradation is different from the brightness of the R component of the area RL4, which is the second overlapping area DR, the gradation distribution of the area RL3, which is the non-overlapping area NR, changes continuously or stepwise, so that a difference between the brightness of the R component of the area RL1 at the maximum gradation and the brightness of the R component of the area RL4 is less noticeable.

(Appendix 2) The correction method according to Appendix 1, in which each of the plurality of pieces of gradation data includes at least one gradation value indicating at least one gradation for each of a plurality of color components further including a second color component and a third color component, each of the plurality of pieces of measurement data includes a brightness value indicating brightness of reflected light of colored light corresponding to each of the plurality of color components further including the second color component and the third color component having the at least one gradation value, the calculating the correction data includes determining a third target value that is a target of brightness of the second color component in the first area and a fourth target value that is a target of brightness of the second color component in the second area based on the plurality of pieces of gradation data and the plurality of pieces of measurement data, calculating the correction value of the parameter that defines the brightness of the third area, based on the third target value and the fourth target value, so that the distribution of the parameter is a continuous or stepwise distribution in the first direction from the first area toward the second area, determining a fifth target value that is a target of brightness of the third color component in the first area and a sixth target value that is a target of brightness of the third color component in the second area based on the plurality of pieces of gradation data and the plurality of pieces of measurement data, and calculating the correction value of the parameter that defines the brightness of the third area, based on the fifth target value and the sixth target value, so that the distribution of the parameter is a continuous or stepwise distribution in the first direction from the first area toward the second area.

With the configuration described above, in the correction method of Appendix 2, even when the brightness of the R component, the G component, and the B component of the area RL1, which is the first overlapping area DR, at the maximum gradation is different from the brightness of the R component, the G component, and the B component of the area RL4, which is the second overlapping area DR, the gradation distribution of the area RL3, which is the non-overlapping area NR, changes continuously or stepwise, so that the difference between the brightness of the R component, the G component, and the B component of the area RL1 at the maximum gradation and the brightness of the R component, the G component, and the B component of the area RL4 is less noticeable.

(Appendix 3) The correction method according to Appendix 1, in which the first area includes a plurality of first portions, the second area includes a plurality of second portions, the third area includes a plurality of third portions, the brightness of the first color component in the first area is an average value of the brightness of the first color component in the plurality of first portions, the brightness of the first color component in the second area is an average value of the brightness of the first color component in the plurality of second portions, and the brightness of the first color component in the third area is brightness in each of the plurality of third portions.

With the configuration described above, the correction method of Appendix 3 can continuously or stepwise change the gradation distribution of the area RL3 based on the average value of the brightness of the R component of the portion PT1 provided in the area RL1 at the maximum gradation and the average value of the brightness of the R component of the portion PT4 provided in the area RL4.

(Appendix 4) The correction method according to Appendix 1, in which the first area includes a first portion adjacent to the third area, the second area includes a second portion adjacent to the third area, the third area includes a plurality of third portions, the brightness of the first color component in the first area is brightness of the first color component in the first portion, the brightness of the first color component in the second area is brightness of the first color component in each of the plurality of second portion, the distribution of the parameter that defines the brightness of the third area being the continuous or stepwise distribution in the first direction from the first area toward the second area means that the brightness of the first color component in each of the plurality of third portions has a continuous or stepwise distribution in the first direction from the first area toward the second area, and the first portion, the second portion, and the plurality of third portions are aligned in one direction.

With the configuration described above, the correction method of Appendix 4 can continuously or stepwise change the gradation distribution of the area RL3 based on the brightness of the R component of the portion PT1 adjacent to the area RL3 provided in the area RL1 at the maximum gradation and the brightness of the R component of the portion PT4 adjacent to the area RL3 provided in the area RL4.

(Appendix 5) The correction method according to Appendix 1, the first area including a first portion, the second area including a second portion, the third area including a plurality of third portions including a first adjacent portion adjacent to the first area and a second adjacent portion adjacent to the second area, and the correction method further including: determining a seventh target value that is a target of brightness of the first color component in the first adjacent portion based on the first target value so that brightness of the first area, the second area, and the third area is uniform; and determining an eighth target value that is a target of brightness of the first color component in the second adjacent portion based on the second target value so that brightness of the first area, the second area, and the third area is uniform, in which the first portion, the second portion, and the plurality of third portions are aligned in one direction.

With the configuration described above, the correction method of Appendix 5 optimizes the gradation values of the color components of the first adjacent portion GP1 adjacent to the area RL1 and the second adjacent portion GP2 adjacent to the area RL4 in the area RL3.

(Appendix 6) The correction method according to Appendix 5, in which the plurality of third portions further include a plurality of intermediate portions between the first adjacent portion and the second adjacent portion, and the calculating of the correction value of the parameter based on the first target value and the second target value so that the distribution of the parameter that defines the brightness in the third area is the continuous or stepwise distribution in the first direction from the first area toward the second area includes determining a ninth target value that is a target of brightness of the first color component in each of the plurality of intermediate portions based on the seventh target value and the eighth target value.

With the configuration described above, the correction method of Appendix 6 can optimize the gradation value of each of the plurality of intermediate portions CP.

(Appendix 7) The correction method according to Appendix 5, the first area including a plurality of the first portions, and the correction method further including: acquiring a captured image of the first area; specifying brightness of the plurality of first portions and chromaticities of the plurality of first portions in the captured image; maintaining the brightness of the plurality of first portions at brightness corresponding to the first target value; and adjusting the chromaticities of the plurality of first portions to a same value.

With the configuration described above, the correction method of Appendix 7 can eliminate the black color unevenness.

(Appendix 8) A projecting that apparatus executes: acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data; and calculating correction data for correcting a color of an image displayed on the projection surface based on the plurality of pieces of gradation data and the plurality of pieces of measurement data, in which the projection image has a first area overlapping the first projection image, a second area overlapping the second projection image, and a third area not overlapping the first projection image and the second projection image in a state in which the projection image is projected onto the projection surface, the plurality of pieces of gradation data include at least one gradation value indicating at least one gradation of a first color component, the plurality of pieces of measurement data include a brightness value indicating brightness of reflected light of colored light corresponding to the first color component having the at least one gradation value, and the calculating the correction data includes determining a first target value that is a target of brightness of the first color component in the first area and a second target value that is a target of brightness of the first color component in the second area based on the plurality of pieces of gradation data and the plurality of pieces of measurement data, and calculating a correction value of a parameter that defines brightness of the third area, based on the first target value and the second target value, so that a distribution of the parameter is a continuous or stepwise distribution in a first direction from the first area toward the second area.

With the configuration described above, the projecting apparatus according to Appendix 8 can correct black color unevenness and the brightness in the projection image PI when a tiled display is performed using the plurality of projecting apparatuses 10 without deteriorating the contrast ratio in the entire projection image PI.

Specifically, even if the brightness of the R component of the area RL1, which is the first overlapping area DR, at the maximum gradation is different from the brightness of the R component of the area RL4, which is the second overlapping area DR, the gradation distribution of the area RL3, which is the non-overlapping area NR, changes continuously or stepwise, so that a difference between the brightness of the R component of the area RL1 at the maximum gradation and the brightness of the R component of the area RL4 is less noticeable.

(Appendix 9) A non-transitory computer-readable storage medium storing a program, the program comprising causing a projecting apparatus to execute acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data, and calculating correction data for correcting a color of an image displayed on the projection surface based on the plurality of pieces of gradation data and the plurality of pieces of measurement data, in which the projection image has a first area overlapping the first projection image, a second area overlapping the second projection image, and a third area not overlapping the first projection image and the second projection image in a state in which the projection image is projected onto the projection surface, the plurality of pieces of gradation data include at least one gradation value indicating at least one gradation of a first color component, the plurality of pieces of measurement data include a brightness value indicating brightness of reflected light of colored light corresponding to the first color component having the at least one gradation value, and the calculating the correction data includes determining a first target value that is a target of brightness of the first color component in the first area and a second target value that is a target of brightness of the first color component in the second area based on the plurality of pieces of gradation data and the plurality of pieces of measurement data, and calculating a correction value of a parameter that defines brightness of the third area, based on the first target value and the second target value, so that a distribution of the parameter is a continuous stepwise distribution in a first direction from the first area toward the second area.

With the configuration described above, the non-transitory computer-readable storage medium storing a program according to Appendix 9 can correct the black color unevenness and the brightness in the projection image PI when a tiled display is performed using the plurality of projecting apparatuses 10 without deteriorating the contrast ratio in the entire projection image PI.

Specifically, even if the brightness of the R component of the area RL1, which is the first overlapping area DR, at the maximum gradation is different from the brightness of the R component of the area RL4, which is the second overlapping area DR, the gradation distribution of the area RL3, which is the non-overlapping area NR, changes continuously or stepwise, so that a difference between the brightness of the R component of the area RL1 at the maximum gradation and the brightness of the R component of the area RL4 is less noticeable.

What is claimed is:

1. A correction method for a projection image projected from a projecting apparatus, the correction method comprising:
acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data; and
calculating correction data for correcting a color of an image displayed on the projection surface based on the plurality of pieces of gradation data and the plurality of pieces of measurement data, wherein
the projection image has a first area overlapping the first projection image, a second area overlapping the second projection image, and a third area not overlapping the first projection image and the second projection image in a state in which the projection image is projected onto the projection surface,
the plurality of pieces of gradation data include at least one gradation value indicating at least one gradation of a first color component,
the plurality of pieces of measurement data include a brightness value indicating brightness of reflected light of colored light corresponding to the first color component having the at least one gradation value, and
the calculating the correction data includes
determining a first target value that is a target of brightness of the first color component in the first area and a second target value that is a target of brightness of the first color component in the second area based on the plurality of pieces of gradation data and the plurality of pieces of measurement data, and
calculating a correction value of a parameter that defines brightness of the third area, based on the first target value and the second target value, so that a distribution of the parameter is a continuous or stepwise distribution in a first direction from the first area toward the second area.

2. The correction method according to claim 1, wherein
each of the plurality of pieces of gradation data includes at least one gradation value indicating at least one gradation for each of a plurality of color components further including a second color component and a third color component,
each of the plurality of pieces of measurement data includes a brightness value indicating brightness of reflected light of colored light corresponding to each of the plurality of color components further including the second color component and the third color component having the at least one gradation value,
the calculating the correction data includes
determining a third target value that is a target of brightness of the second color component in the first area and a fourth target value that is a target of brightness of the second color component in the second area based on the plurality of pieces of gradation data and the plurality of pieces of measurement data,
calculating the correction value of the parameter that defines the brightness of the third area, based on the third target value and the fourth target value, so that the distribution of the parameter is a continuous or stepwise distribution in the first direction from the first area toward the second area,
determining a fifth target value that is a target of brightness of the third color component in the first area and a sixth target value that is a target of brightness of the third color component in the second area based on the plurality of pieces of gradation data and the plurality of pieces of measurement data, and
calculating the correction value of the parameter that defines the brightness of the third area, based on the fifth target value and the sixth target value, so that the distribution of the parameter is a continuous or stepwise distribution in the first direction from the first area toward the second area.

3. The correction method according to claim 1, wherein
the first area includes a plurality of first portions,
the second area includes a plurality of second portions,
the third area includes a plurality of third portions,
the brightness of the first color component in the first area is an average value of the brightness of the first color component in the plurality of first portions,
the brightness of the first color component in the second area is an average value of the brightness of the first color component in the plurality of second portions, and
the brightness of the first color component in the third area is brightness in each of the plurality of third portions.

4. The correction method according to claim 1, wherein
the first area includes a first portion adjacent to the third area,
the second area includes a second portion adjacent to the third area,
the third area includes a plurality of third portions,
the brightness of the first color component in the first area is brightness of the first color component in the first portion,
the brightness of the first color component in the second area is brightness of the first color component in each of the plurality of second portion,
the distribution of the parameter that defines the brightness of the third area being the continuous or stepwise distribution in the first direction from the first area toward the second area means that the brightness of the first color component in each of the plurality of third portions has a continuous or stepwise distribution in the first direction from the first area toward the second area, and
the first portion, the second portion, and the plurality of third portions are aligned in one direction.

5. The correction method according to claim 1,
the first area including a first portion,
the second area including a second portion,
the third area including a plurality of third portions including a first adjacent portion adjacent to the first area and a second adjacent portion adjacent to the second area, and
the correction method further comprising:
determining a seventh target value that is a target of brightness of the first color component in the first adjacent portion based on the first target value so that brightness of the first area, the second area, and the third area is uniform; and
determining an eighth target value that is a target of brightness of the first color component in the second adjacent portion based on the second target value so that brightness of the first area, the second area, and the third area is uniform, wherein
the first portion, the second portion, and the plurality of third portions are aligned in one direction.

6. The correction method according to claim 5, wherein
the plurality of third portions further include a plurality of intermediate portions between the first adjacent portion and the second adjacent portion, and
the calculating of the correction value of the parameter based on the first target value and the second target value so that the distribution of the parameter that defines the brightness in the third area is the continuous or stepwise distribution in the first direction from the first area toward the second area includes determining a ninth target value that is a target of brightness of the first color component in each of the plurality of intermediate portions based on the seventh target value and the eighth target value.

7. The correction method according to claim 5,
the first area including a plurality of the first portions, and
the correction method further comprising:
acquiring a captured image of the first area;
specifying brightness of the plurality of first portions and chromaticities of the plurality of first portions in the captured image;
maintaining the brightness of the plurality of first portions at brightness corresponding to the first target value; and
adjusting the chromaticities of the plurality of first portions to a same value.

8. A projecting apparatus that executes:
acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data; and
calculating correction data for correcting a color of an image displayed on the projection surface based on the plurality of pieces of gradation data and the plurality of pieces of measurement data, wherein
the projection image has a first area overlapping the first projection image, a second area overlapping the second projection image, and a third area not overlapping the first projection image and the second projection image in a state in which the projection image is projected onto the projection surface,
the plurality of pieces of gradation data include at least one gradation value indicating at least one gradation of a first color component,
the plurality of pieces of measurement data include a brightness value indicating brightness of reflected light of colored light corresponding to the first color component having the at least one gradation value, and
the calculating the correction data includes
determining a first target value that is a target of brightness of the first color component in the first area and a second target value that is a target of brightness of the first color component in the second area based on the plurality of pieces of gradation data and the plurality of pieces of measurement data, and
calculating a correction value of a parameter that defines brightness of the third area, based on the first target value and the second target value, so that a distribution of the parameter is a continuous or stepwise distribution in a first direction from the first area toward the second area.

9. A non-transitory computer-readable storage medium storing a program, the program comprising causing a projecting apparatus to execute
acquiring a plurality of pieces of measurement data corresponding one-to-one to a plurality of pieces of gradation data based on an output from a sensor that measures reflected light reflected by a projection surface, when a first projecting apparatus projects a plurality of types of first colored light, which correspond one-to-one to the plurality of pieces of gradation data, onto the projection surface as a first projection image based on the plurality of pieces of gradation data, a second projecting apparatus projects a plurality of types of second colored light, which correspond one-to-one to the plurality of pieces of gradation data, onto the projection surface as a second projection image based on the plurality of pieces of gradation data, and the projecting apparatus projects a plurality of types of third colored light, which correspond one-to-one to the plurality of pieces of gradation data, onto the projection surface as the projection image based on the plurality of pieces of gradation data, and
calculating correction data for correcting a color of an image displayed on the projection surface based on the plurality of pieces of gradation data and the plurality of pieces of measurement data, wherein
the projection image has a first area overlapping the first projection image, a second area overlapping the second projection image, and a third area not overlapping the first projection image and the second projection image in a state in which the projection image is projected onto the projection surface,
the plurality of pieces of gradation data include at least one gradation value indicating at least one gradation of a first color component,
the plurality of pieces of measurement data include a brightness value indicating brightness of reflected light of colored light corresponding to the first color component having the at least one gradation value, and
the calculating the correction data includes
determining a first target value that is a target of brightness of the first color component in the first area and a second target value that is a target of brightness of the first color component in the second area based on the plurality of pieces of gradation data and the plurality of pieces of measurement data, and
calculating a correction value of a parameter that defines brightness of the third area, based on the first target value and the second target value, so that a distribution of the parameter is a continuous or stepwise distribution in a first direction from the first area toward the second area.
